(19) United States
(12) Patent Application Publication
(10) Pub. No.: US 2026/0220619 A1
(43) Pub. Date: Jul. 30, 2026

(54) SYSTEMS AND METHODS FOR MANAGING REPAIRS

(71) Applicant: VISKOOT LLC, McLean, VA (US)

(72) Inventors: Hamid Reza SHAFIE, McLean, VA (US); Haobo CHENG, Arlington, VA (US); Nathan Junyao ZHU, McLean, VA (US); Ruitao ZHANG, Arlington, VA (US); Henry DUONG, Manassas, VA (US); Debrup BASU, Arlington, VA (US)

(21) Appl. No.: 19/629,850

(22) Filed: Mar. 26, 2026

Related U.S. Application Data
(63) Continuation-in-part of application No. 18/812,478, filed on Aug. 22, 2024.
(60) Provisional application No. 63/535,461, filed on Aug. 30, 2023.

(51) Int. Cl. G06Q 10/20

(52) U.S. Cl. CPC G06Q 10/20

(57) ABSTRACT

A system manages device diagnosis and repair workflows using a mobile application and a server-based repair application. The mobile application captures images of a device, computes objective image-quality values including focus or illumination scores, rejects images failing a threshold, and extracts feature descriptors from accepted images for transmission without sending the images. The server-based repair application compares descriptors to stored fault signatures to produce confidence-ranked fault classifications and, when confidence is below a threshold, requests additional captures from predetermined viewpoints using region-of-interest templates until confidence is satisfied or a capture limit is reached. Repair progression is enforced by a server-side state machine that permits only validated state transitions, while clients display only validated states. Replacement workflows may be initiated for non-repairable devices.

### CROSS-REFERENCE TO RELATED APPLICATIONS

This application is a continuation-in-part of U.S. patent application Ser. No. 18/812,478, filed Aug. 22, 2024, which claims priority to U.S. Provisional Application Ser. No. 63/535,461, filed Aug. 30, 2023, the entire contents of which are hereby incorporated by reference in their entireties.

### FIELD OF THE INVENTION

The present invention relates to systems and methods for managing service and repair of devices using a mobile application and a server-based repair application, including image-based fault identification, automated comparison of extracted device features with stored fault signatures using artificial intelligence and machine-learning classification techniques, cloud-based processing, and server-controlled workflow state management for coordinating repair actions and communications with a manufacturer or repair facility portal.

The present invention further relates to systems and methods for managing service of medical devices, power tools, and other serviceable equipment through image-based fault identification and server-controlled workflow execution, including coordination between device operators, manufacturers, and repair centers via a mobile application and a server-managed repair platform that controls repair case creation, repair execution, and replacement workflows.

### BACKGROUND

Repair and maintenance of complex equipment—including medical devices, dental equipment, veterinary equipment, industrial power tools, and related machinery—typically rely on manual workflows involving shipment, inspection, technician diagnosis, and coordination between device operators and service facilities. Diagnostic accuracy often depends on technician expertise and device-specific documentation, which can result in inconsistent troubleshooting outcomes and delays in repair execution. Such workflows typically lack automated mechanisms for verifying image capture quality or performing machine-based fault classification prior to device shipment.

Modern device platforms undergo frequent hardware and firmware revisions, reducing product lifecycle duration and increasing the difficulty of maintaining up-to-date diagnostic expertise across multiple device models. Manual troubleshooting processes are often time-consuming and commonly require shipment of devices prior to fault identification, thereby extending downtime and operational disruption.

Device malfunction or extended repair delays may interrupt operations in clinical, industrial, or safety-critical environments. Publicly available safety data indicate that adverse events are frequently associated with device malfunction or misuse. Delays in diagnosis, repair authorization, or service coordination may therefore contribute to increased operational risk in environments that depend on reliable equipment performance.

Existing repair management systems generally lack automated mechanisms that combine objective image capture validation, image-based fault identification, and server-enforced repair workflow control capable of validating repair states and coordinating repair or replacement decisions through machine-controlled processes. Improvements are therefore needed in systems that enable automated device fault diagnosis and controlled execution of repair workflows across manufacturers, service providers, and equipment operators.

### SUMMARY

It is an object of the present invention to provide an application platform including a mobile application for end-users and a manufacturer portal for service facilities, wherein a server-based repair application coordinates the repair journey from repair request initiation through return shipment or other service completion.

The mobile application captures device information and supports automated diagnosis by extracting feature descriptors from captured images and transmitting the feature descriptors to the server-based repair application without transmitting the captured images, wherein images failing objective image-quality thresholds are rejected and recapture is requested, and wherein additional image capture is automatically requested when fault classification confidence fails to satisfy a threshold; and the server-based repair application identifies a fault classification and provides corrective guidance or initiates a repair case when service is indicated.

The mobile application provides status visibility for steps of the repair journey using server-validated workflow updates generated by the server-based repair application, and the mobile application presents required end-user actions including repair authorization, shipment initiation, or disposition selection for a non-repairable device.

When a device is non-repairable or when a repair cost evaluation satisfies a threshold, the server-based repair application initiates a replacement workflow and enables in-application presentation of compatible replacement options, while allowing the end-user to accept replacement, decline repair, request return, or request disposal.

In other embodiments, the application platform is configured for power tools and other serviceable equipment using the same mobile application, manufacturer portal, and server-based repair application to coordinate repair intake, workflow progression, status updates, and replacement workflows.

The server-based repair application enforces repair execution using machine-defined workflow states and transition rules so that workflow advancement occurs only upon permitted state transitions determined by machine-defined transition rules, and the mobile application displays only server-validated workflow state information.

The mobile application may support shipment label generation, pickup scheduling, or onsite service scheduling based on device type and service requirements, wherein such actions are coordinated by server-controlled workflow transitions.

The manufacturer portal synchronizes with the server-based repair application to receive repair cases, record service actions, and advance workflow state when permitted, while the mobile application reflects workflow state changes only through validated updates.

### BRIEF DESCRIPTION OF THE DRAWINGS

FIG. 1 depicts a network diagram of the repair management system according to an embodiment of the invention.

FIG. 2 depicts a flowchart showing an example descriptor-based process for determining a medical-device fault classification or error code according to an embodiment of the invention.

FIG. 3 depicts a scanner for a mobile application according to an embodiment of the invention.

FIG. 4 depicts an image of a medical device with a displayed error code according to an embodiment of the invention.

FIG. 5 depicts an example error message for troubleshooting according to an embodiment of the invention.

FIG. 6 depicts a flowchart showing the capabilities and features of a mobile application according to an embodiment of the invention.

FIG. 7 depicts an example dashboard for the mobile application according to an embodiment of the invention.

FIG. 8 depicts an example select product type screen according to an embodiment of the invention.

FIG. 9 depicts an example product selection size screen according to an embodiment of the invention.

FIG. 10 depicts an example product information screen according to an embodiment of the invention.

FIG. 11 depicts an example shipping option screen according to an embodiment of the invention.

FIG. 12 depicts an example survey screen according to an embodiment of the invention.

FIG. 13 depicts an example submission screen according to an embodiment of the invention.

FIG. 14 depicts a repair order added to the dashboard according to an embodiment of the invention.

FIG. 15 depicts an example milestone screen according to an embodiment of the invention.

FIG. 16 depicts an example repair report screen according to an embodiment of the invention.

FIG. 17 depicts an example repair exchange program screen according to an embodiment of the invention.

FIG. 18 depicts an example screen showing a repair is possible according to an embodiment of the invention.

FIG. 19 depicts an example financial transaction screen according to an embodiment of the invention.

FIG. 20 depicts an example listing of repairs according to an embodiment of the invention.

FIG. 21 depicts the primary components of the manufacturer portal according to an embodiment of the invention.

FIG. 22 depicts an example monitor board in accordance with an embodiment of the invention.

FIG. 23 depicts an example receive shipment panel according to an embodiment of the invention.

FIG. 24 depicts an example status screen according to an embodiment of the invention.

FIG. 25 depicts an example scan screen according to an embodiment of the invention.

FIG. 26 depicts example decoded information screen according to an embodiment of the invention.

FIG. 27 depicts an example supervisor panel according to an embodiment of the invention.

FIG. 28 depicts a pop-up window according to an embodiment of the invention.

FIG. 29 depicts an example technician panel according to an embodiment of the invention.

FIG. 30 depicts an example repair update screen according to an embodiment of the invention.

FIG. 31 depicts an example product recommendation flowchart according to an embodiment of the invention.

FIG. 32 depicts a network diagram of the repair management system according to an embodiment of the invention.

FIG. 33 depicts a flowchart showing the capabilities and features of a mobile application according to an embodiment of the invention.

FIG. 34 depicts an example dashboard for the mobile application according to an embodiment of the invention.

FIG. 35 depicts an example select product type screen according to an embodiment of the invention.

FIG. 36 depicts an example product information screen according to an embodiment of the invention.

FIG. 37 depicts an example shipping option screen according to an embodiment of the invention.

FIG. 38 depicts an example submission screen according to an embodiment of the invention.

FIG. 39 depicts a repair order added to the dashboard according to an embodiment of the invention.

FIG. 40 depicts an example milestone screen according to an embodiment of the invention.

FIG. 41 depicts an example repair report screen according to an embodiment of the invention.

FIG. 42 depicts an example repair exchange program screen according to an embodiment of the invention.

FIG. 43 depicts an example screen showing a repair is not possible according to an embodiment of the invention.

FIG. 44 depicts a product recommendation screen according to an embodiment of the invention.

FIG. 45 depicts an example listing of repairs according to an embodiment of the invention.

FIG. 46 depicts the primary components of the manufacturer portal according to an embodiment of the invention.

FIG. 47 depicts an example monitor board in accordance with an embodiment of the invention.

FIG. 48 depicts an example receive shipment panel according to an embodiment of the invention.

FIG. 49 depicts an example status screen according to an embodiment of the invention.

FIG. 50 depicts an example scan screen according to an embodiment of the invention.

FIG. 51 depicts an example decoded information screen according to an embodiment of the invention.

FIG. 52 depicts an example supervisor panel according to an embodiment of the invention.

FIG. 53 depicts a pop-up window according to an embodiment of the invention.

FIG. 54 depicts an example technician panel according to an embodiment of the invention.

FIG. 55 depicts an example repair update screen according to an embodiment of the invention.

FIG. 56 depicts an example product recommendation flowchart according to an embodiment of the invention.

FIG. 57 depicts a flowchart illustrating objective image-quality gating and region-of-interest (ROI) template enforcement prior to feature extraction according to an embodiment of the invention.

FIG. 58 depicts an example mobile user interface overlay enforcing product-type-specific capture constraints including an ROI overlay template and capture guidance according to an embodiment of the invention.

FIG. 59 depicts a block diagram illustrating on-device feature descriptor extraction and transmission of descriptors without transmitting a captured image to a server according to an embodiment of the invention.

FIG. 60 depicts a flowchart illustrating confidence-driven closed-loop capture control using predetermined viewpoint prompts and ROI templates to request additional image captures when confidence is below a threshold according to an embodiment of the invention.

FIG. 61 depicts a functional block diagram illustrating similarity scoring, confidence scoring, and multi-view consistency verification to rank candidate fault classifications according to an embodiment of the invention.

FIG. 62 depicts a procedure diagram illustrating stepwise corrective action instructions with machine-gated step progression based on machine-verifiable confirmation conditions according to an embodiment of the invention.

FIG. 63 depicts a state diagram illustrating a server-defined repair workflow state machine and a server-side transition table that permits advancement between workflow states only when corresponding transition rules are satisfied according to an embodiment of the invention.

FIG. 64 depicts an eventing diagram illustrating state-transition event generation and mobile validation using a state version value and an event nonce to prevent stale or replayed updates according to an embodiment of the invention.

FIG. 65 depicts a diagram illustrating validation of an integrity value encoded in a machine-readable code prior to verifying receipt of a consumer product and transitioning a repair workflow state according to an embodiment of the invention.

FIG. 66 depicts a flowchart illustrating initiation of a replacement workflow, verification of an entitlement credential, and issuance and application of a cryptographically signed discount token bound to a repair order identifier and an expiration time according to an embodiment of the invention.

FIG. 67 depicts a block diagram illustrating computation of a compatibility signature including an interface profile hash and filtering of replacement product candidates based on compatibility rules and availability to output recommended replacement products according to an embodiment of the invention.

In one or more implementations, not all of the depicted components, modules, user interface elements, workflows, state machines, events, or processing blocks in each figure may be required, and one or more implementations may include additional components, modules, workflow steps, state transitions, or data flows not shown in a figure. Variations in the arrangement, interconnection, and type of the components, modules, workflows, or state machines may be made without departing from the scope of the subject disclosure. Additional components, different components, fewer components, different workflow steps, additional or fewer state transitions, or alternative event sequences may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

In a preferred implementation, the subject technology provides a technical improvement to image-based fault identification by (i) objectively evaluating image quality prior to feature extraction, (ii) enforcing product-type-specific capture constraints using region-of-interest (ROI) templates, and (iii) employing a closed-loop, confidence-driven capture process to request additional viewpoints when confidence is below a threshold.

In a preferred implementation, the subject technology further improves privacy and bandwidth usage by extracting and transmitting feature descriptors from a captured image without transmitting the captured image itself to a remote server.

In a preferred implementation, the subject technology further improves reliability of status tracking by using server-defined workflow states and transmitting state-transition events that include at least a version value and an event nonce, allowing a client application to reject stale or replayed events.

### Medical Device Repair

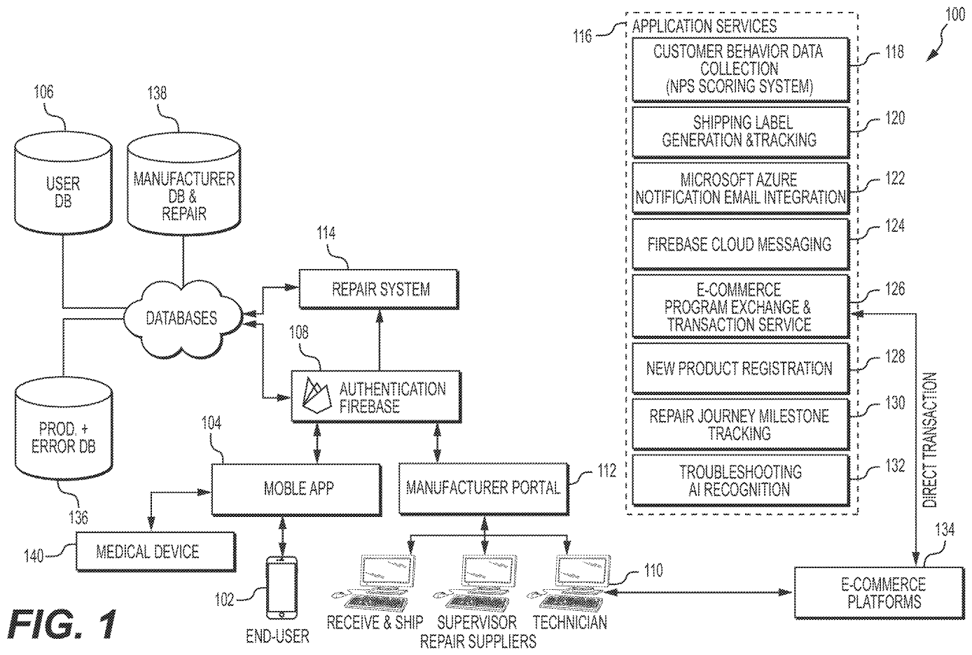

Referring first to FIG. 1, depicted is a network diagram of repair management system 100 showing the connection between end-users, manufacturers, and repair technicians through the mobile application and back-end. End-users 102 can access mobile application 104 by downloading a dedicated mobile application to a smartphone or tablet. Alternatively, the end-user can access a web-app through a browser that provides similar functionality to the mobile application 104. In order to use mobile application 104, each end-user 102 must register with repair management system 100. Identifying information such as name, company, address, etc. is collected from each end-user 102 and is stored in user database 106. This allows all repairs received within repair management system 100 to be associated with a particular end-user 102.

In a preferred embodiment, Firebase authentication service 108 is utilized because it supports authentication using passwords, phone numbers, and log-in through popular identity providers like Google, Facebook, Twitter, etc. Firebase authentication service 108 can also support other forms of authentication such as fingerprint identification, multi-factor authentication, or facial recognition. It should be apparent to one of ordinary skill in the art that any secure authentication system may be utilized.

In a preferred embodiment, Firebase authentication service 108 is utilized to authenticate both end-users 102 and repair suppliers 110. However, separate systems may be utilized if different levels of authentication are needed.

Repair suppliers 110 may be third-party repair technicians or manufacturers. Access to repair management system 100 for repair suppliers 110 can be accessed through manufacturer portal 112 using a dedicated mobile application (like with end-users 102) or a web application provided through a browser.

Communication and interaction between mobile application 104 and manufacturer portal 112 is managed by repair system 114. Further, repair system 114 also controls the various application services 116 used to manage repair management system 100. Application services 116 may include, but are not limited to, customer data collection system 118, shipping label generator & tracker 120, notification system 122, messaging system 124, financial transaction system 126, product registration system 128, repair update and tracking system 130, and AI module 132. In a preferred embodiment, repair update and tracking system 130 implements a machine-defined workflow comprising a plurality of states and a server-side state transition table, and transmits state-transition events to mobile application 104 when a state change is permitted by a transition rule.

In a preferred embodiment, mobile application 104 includes a feature extraction pipeline configured to extract feature descriptors from captured images and transmit the feature descriptors to AI module 132 without transmitting the captured images. The feature descriptors may include local descriptors computed from keypoints and/or a compact embedding generated by a trained model.

In a preferred embodiment, mobile application 104 transmits, along with feature descriptors, capture metadata including a product type identifier, a region-of-interest identifier, and a viewpoint identifier corresponding to a prompted capture viewpoint. The captured image itself may be discarded locally after descriptor extraction, or retained locally for a limited time under an end-user controlled setting.

In a preferred embodiment, repair system 114 transmits workflow updates as signed or integrity-protected events including at least a repair order identifier, a state version value, and an event nonce. Mobile application 104 validates received events and updates a displayed repair status solely based on validated events, thereby preventing stale, out-of-order, or replayed status updates from being displayed. In a preferred embodiment, a state-transition event is generated upon a permitted state advancement, and the event nonce is used to detect replay of a previously transmitted state-transition event. Mobile application 104 discards a workflow update when a version value is stale or when the event nonce indicates a repeated event.

In an alternative embodiment, the mobile application 104 may suggest new or replacement items to end-users 102 if it is determined that repairs cannot be completed. For example, manufacturer database 138 can store a list of related or suitable replacement items in association with each power tool. End-users 102 can utilize e-commerce platforms 134 to purchase any needed medical devices directly from the manufacturer.

As will be discussed in greater detail later, AI module 132 is able to detect error messages and provide troubleshooting for medical devices 140. In a preferred embodiment, end-user 102 uses mobile application 104 to capture one or more images associated with a fault indication on medical device 140 (e.g., an error code or error message displayed on a display panel). Prior to feature extraction, mobile application 104 objectively evaluates image quality using one or more computed image-quality scores and rejects images failing an objective image-quality threshold, prompting the end-user 102 to recapture. For an accepted image, mobile application 104 preprocesses the image and extracts feature descriptors. In a preferred embodiment, the feature descriptors are transmitted to AI module 132 without transmitting the captured image. AI module 132 compares the feature descriptors to fault signatures in a product database and returns a selected fault classification, associated confidence, and corrective action instructions, and mobile application 104 may enable initiation of a repair case based on the selected fault classification.

In a preferred embodiment, the objective image-quality scores include at least a focus score and an illumination score. The focus score may be computed using an edge-based sharpness metric, and the illumination score may be computed based on a luminance distribution, saturation percentage, or underexposure/overexposure detection. Images that fail the objective image-quality threshold are rejected prior to feature extraction to reduce false matches and improve reliability.

In a preferred embodiment, mobile application 104 provides product-type-specific capture guidance that defines a region-of-interest template (e.g., a rectangular overlay aligned to a display panel area) and/or an image capture angle range. The mobile application 104 machine-enforces the capture guidance by rejecting images that do not satisfy the region-of-interest template coverage requirement and/or an angle constraint.

In a preferred embodiment, AI module 132 computes a confidence score for a highest-ranked candidate fault classification. When the confidence score is below a confidence threshold, AI module 132 initiates a closed-loop capture control process by prompting mobile application 104 to request capture of an additional image from an additional viewpoint selected from a predetermined set of viewpoint prompts associated with a product type and a region-of-interest template.

Example viewpoint prompts may include “capture the full front of the device,” “capture the display panel close-up,” “capture the product label/serial plate,” or “capture a connector/port area,” depending on the product type. The closed-loop process repeats comparison and ranking using descriptors from the additional image until (i) the confidence score satisfies the confidence threshold or (ii) a maximum number of image captures is reached.

If the maximum number of image captures is reached without meeting the confidence threshold, mobile application 104 may present a fallback option to initiate a repair case with an “insufficient confidence” flag, optionally attaching the descriptors and capture metadata for technician review.

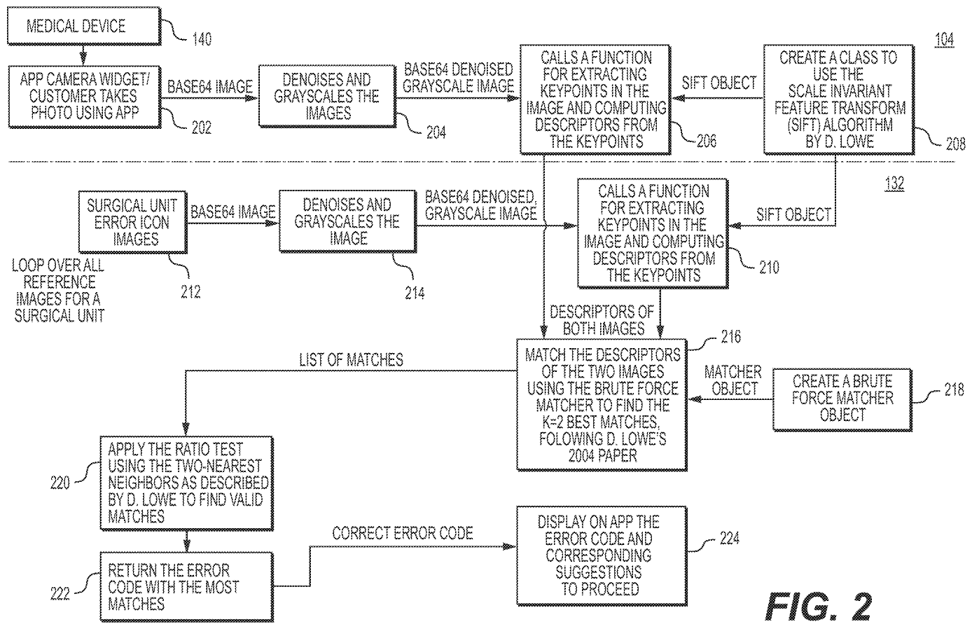

FIG. 2 depicts an example sequence utilized by AI module 132 and mobile application 104 to determine a fault classification for a medical device 140 and to provide corresponding corrective action information. In step 202, end-user 102 uses mobile application 104 to capture an image associated with a fault indication of medical device 140. In step 204, the captured image may be preprocessed, including one or more denoising, grayscale conversion, or illumination normalization. In some embodiments, one or more surgical unit error icon images 212 are used as reference images, and such reference images may likewise be preprocessed in step 214. In step 206, feature descriptors are extracted from the captured image. In one embodiment, mobile application 104 creates or invokes a feature-extraction class 208 configured to extract keypoints and compute descriptors from the image, such as by using a scale invariant feature transform (SIFT) implementation. The extracted feature descriptors are then compared, in step 210, against descriptors associated with the reference images 212. In step 216, descriptors of the captured image and the reference image are matched, and a brute force matcher object 218 may be used to generate a list of matches 220. In a preferred embodiment, a ratio test is applied to the candidate matches to identify valid matches. In step 222, AI module 132 returns the error code or other fault classification associated with the strongest valid match result, and, in step 224, mobile application 104 displays the selected fault classification together with corresponding guidance or corrective action information.

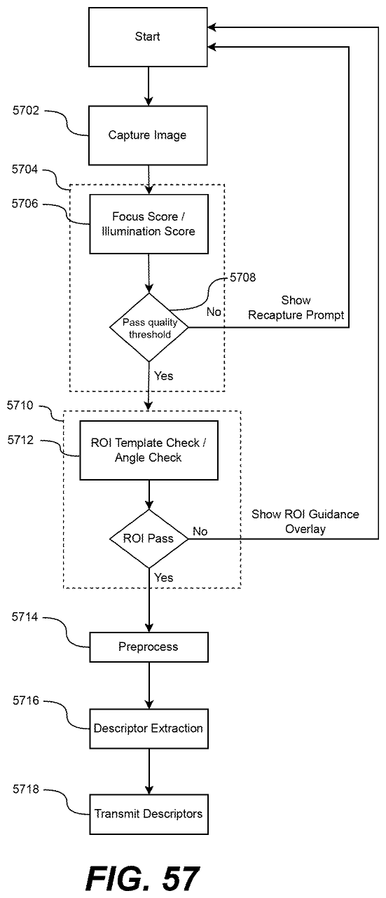

Although FIG. 2 illustrates one example descriptor-based fault-identification flow, additional image-capture validation and classification-control operations may be performed in conjunction with the FIG. 2 sequence. For example, as described with respect to FIGS. 57-61, mobile application 104 may apply objective image-quality thresholding, region-of-interest (ROI) template enforcement, angle-based capture validation, descriptor-only transmission, confidence-driven additional-viewpoint capture, and multi-view consistency verification before a fault classification is selected.

In a preferred embodiment, mobile application 104 utilizes one or more feature extraction techniques including scale invariant feature transform (SIFT), oriented FAST and rotated BRIEF (ORB), or a learned descriptor embedding. In one embodiment, the mobile application 104 creates a class 208 to use the scale invariant feature transform (SIFT) algorithm on the images. For example, the mobile application may utilize a SIFT algorithm described in Lowe, D. “Distinctive image features from scale-invariant keypoints,” International Journal of Computer Vision, Vol. 60, No. 2(2004 ), pp. 91-110, the contents of which are hereby incorporated by reference in their entirety. It should be obvious that other feature extraction techniques or approximations may alternatively be utilized.

The extracted feature descriptors are compared by AI module 132 to fault signatures stored in product database 136 in step 210. In a preferred embodiment, AI module 132 computes a similarity score and a confidence score for each candidate fault classification. In some embodiments, the descriptors computed in steps 206 and 210 are matched in step 216 using a brute force method to find the k=2 best matches. A brute force matcher object 218 may be created for use in the matching process, and a list of matches 220 may be generated. The confidence score may be computed based on a weighted match score including (i) a number of descriptor matches that exceed a similarity threshold, (ii) match quality (e.g., ratio test margin), and (iii) consistency of matches across multiple viewpoints when more than one image has been captured. In a preferred embodiment, a ratio test is applied to the two-nearest neighbors detected in step 216 to identify valid matches, and a cross-view consistency test rejects a candidate fault classification when purported matching descriptors fail a multi-view consistency constraint.

AI module 132 ranks candidate fault classifications based at least in part on confidence scores and selects a highest-ranked candidate fault classification when its confidence score satisfies a confidence threshold. If the confidence score does not satisfy the threshold, AI module 132 transmits a capture request to mobile application 104 identifying an additional viewpoint prompt and an associated ROI template, and steps 202-210 are repeated until the confidence threshold is satisfied or a maximum number of image captures is reached. When a selected fault classification is determined, the correct error code 222 having the most matches may be returned, and, in step 224, mobile application 104 displays the selected fault classification along with a description and corrective action instructions retrieved from product database 136.

AI module 132 may employ a machine-learning model and/or descriptor matching system designed for pattern recognition within images. To train and/or configure the fault classification system, a set of product images and/or derived feature descriptors associated with fault indications (e.g., error codes, display patterns, indicator lights, label patterns) may be collected and stored as fault signatures. Once trained and/or configured, AI module 132 is configured to identify fault indications from received feature descriptors and to output a ranked set of candidate fault classifications with associated confidence scores.

Each fault signature or fault classification may be associated with a corrective action instruction stored in error database 136. The corrective action instruction may include text, a video, or a plurality of images arranged as a stepwise visual procedure. In a preferred embodiment, mobile application 104 machine-enforces a step sequence by gating access to a subsequent step until a confirmation condition is satisfied, wherein the confirmation condition includes a machine-verifiable condition comprising analysis of a verification image captured by the scanning module and validated against a step-specific ROI template and a step-specific image-quality threshold.

### Mobile Application 104 and Interface

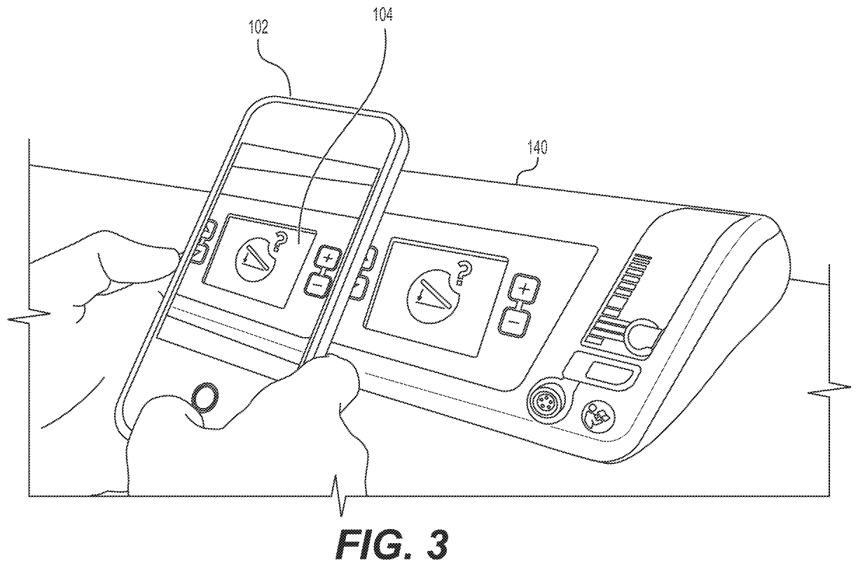

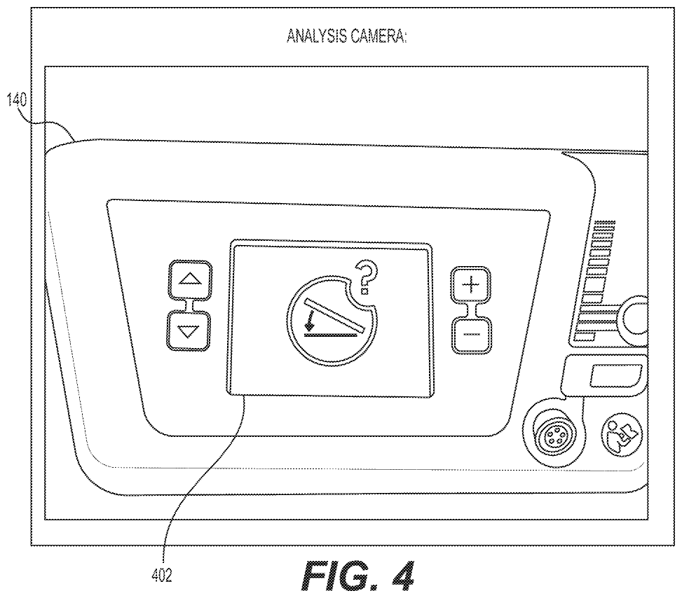

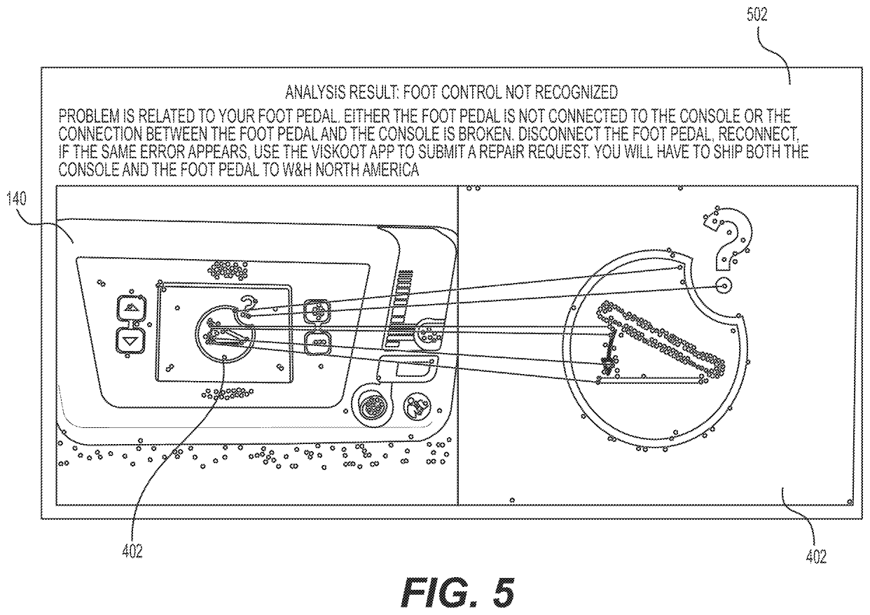

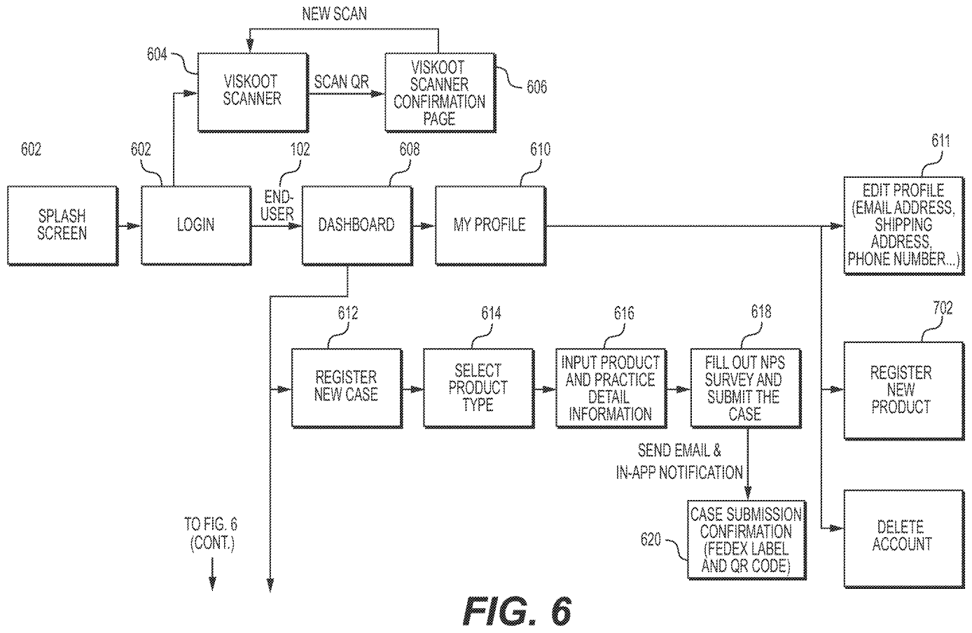

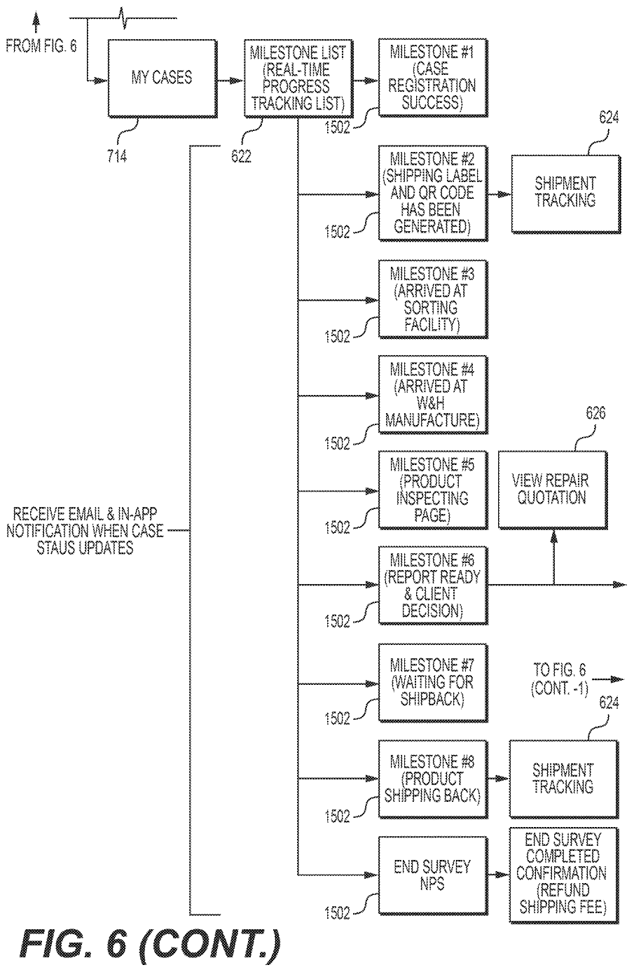

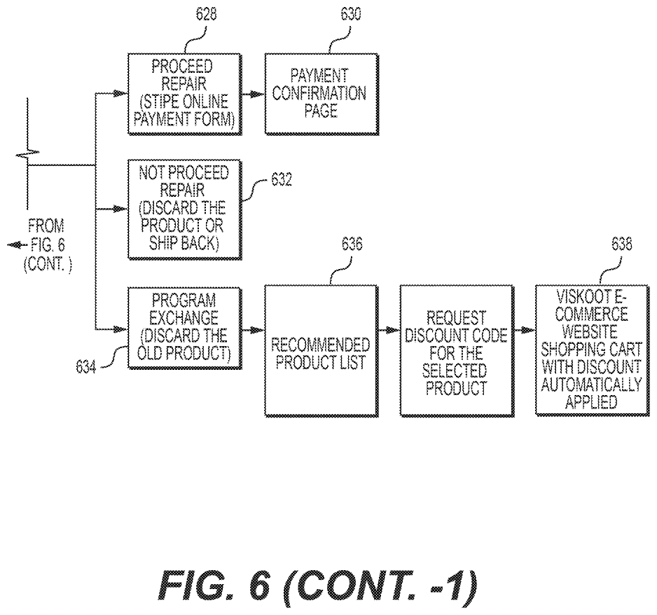

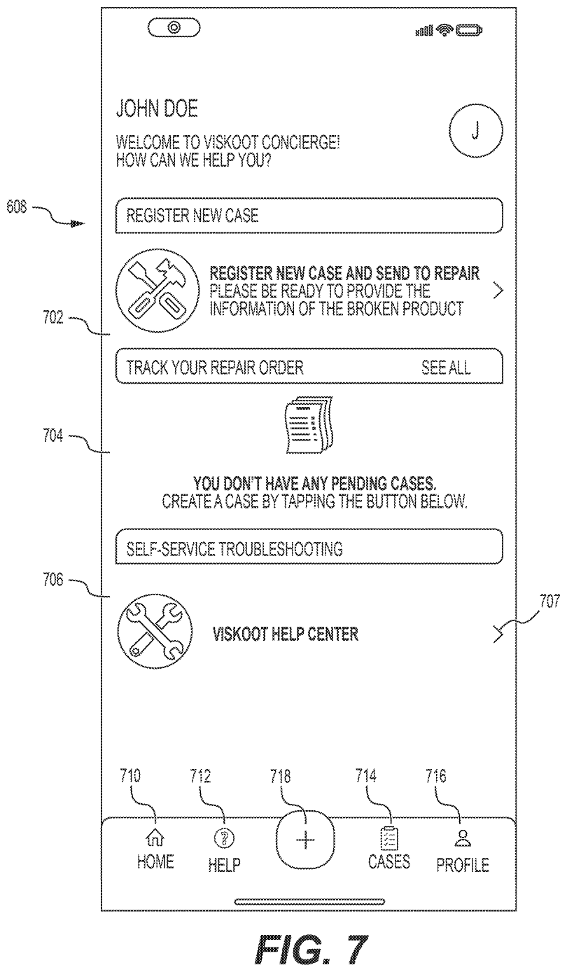

FIG. 6 depicts a flowchart showing the capabilities and features of mobile application 104. The mobile application 104 allows end-user 102 to log in in step 602 and be authenticated through Firebase authentication service 108. After an end-user 102 is authenticated in step 602, a dashboard 608 is displayed to the end-user 102 as depicted in FIG. 7. As further shown in FIG. 6, mobile application 104 may present a scanner splash screen 604 and a scanner confirmation page 606 as part of the scanning and case-submission flow. In a preferred embodiment, dashboard 608 includes sections for registering new case 702 and tracking 704 that provides a listing of active repair cases. Dashboard 608 may further include a repair option 706 and a help center 707. In one embodiment, repair option 706 may be used to initiate a repair request, and help center 707 may provide assistance relating to the repair and return-shipping process. In a preferred embodiment, dashboard 608 further includes a diagnose or scan entry point that initiates the scanning and fault classification process described with respect to FIGS. 2-5, and, upon selection of a fault classification meeting a confidence threshold, enables creation of a repair case record linked to the selected fault classification.

In a preferred embodiment, when a selected fault classification is determined with confidence satisfying a confidence threshold, mobile application 104 creates a case initiation payload including at least a product identifier, the selected fault classification identifier, a confidence value, and capture metadata (e.g., viewpoint identifiers), and transmits the payload to repair system 114 to create a repair case record.

In a preferred embodiment, the repair case record created by repair system 114 includes a server-generated repair order identifier and a state version value. The state version value is incremented by repair system 114 upon each permitted state transition in a server-side workflow.

In a preferred embodiment, mobile application 104 stores the repair order identifier locally and displays it in association with the case listing and milestone indicators, as described below.

In an alternative embodiment, if the fault classification confidence does not satisfy the confidence threshold or the maximum capture count is reached, mobile application 104 enables initiation of a repair case in a manual-review mode, and the repair case record is flagged for technician review.

In a preferred embodiment, the bottom of dashboard 608 includes access menu 708 which is static and is displayed on most pages of mobile application 104. Access menu 708 may provide a home option 710 that can be used to return to dashboard 608 at any point, a help option 712 to access additional help related to the mobile application 104, a cases option 714 allowing the end-user 102 to view all active and closed repair requests, and a profile option 716. If the end-user 102 selects the profile option 716, a my profile screen 610 is displayed listing the profile information saved in mobile application 104 in user database 106. The end-user 102 can select any of the displayed fields such as e-mail address, address, shipping address, phone number, etc. in step 611 to provide new or update profile information. After any changes are made to the information on the my profile screen 610, the user database 106 is updated to reflect the changes. The dashboard also comprises a plus option 718 that can be used to initiate a repair request without the end-user 102 having to return to the dashboard 608. In a preferred embodiment, case status displayed in tracking section 704 is updated solely in response to validated workflow update events received from repair system 114.

In a preferred embodiment, repair system 114 transmits workflow updates as state-transition events including at least the repair order identifier, a state version value, and an event nonce. Mobile application 104 validates the state version value and the event nonce prior to updating a displayed status.

In a preferred embodiment, mobile application 104 discards a received event when (i) the repair order identifier does not match a locally stored repair order identifier for the case, (ii) the state version value is stale relative to a locally stored version value, or (iii) the event nonce indicates a replayed event.

In a preferred embodiment, the event nonce and/or the event payload is integrity-protected using a checksum, message authentication code, or cryptographic signature.

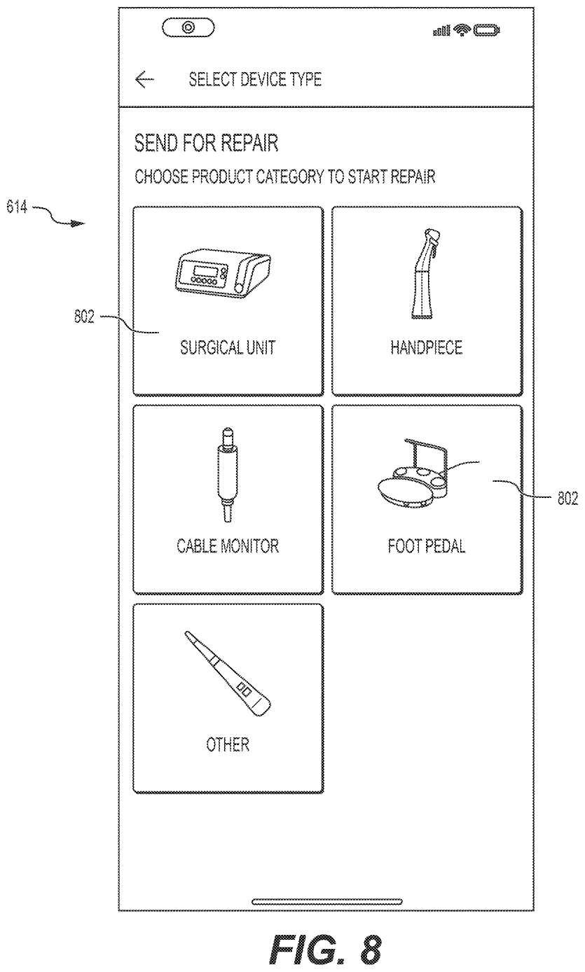

If the end-user 102 selects the plus option 718, or initiates case creation after fault classification as described above, a new repair request is initiated in step 612 so that necessary information regarding the repair request can be collected. In a preferred embodiment, a select product type screen 614 is displayed to the end-user 102 so that a category can be selected as depicted in FIG. 8. Selection options 802 may include surgical unit, hand piece, cable monitor, foot pedal, or other.

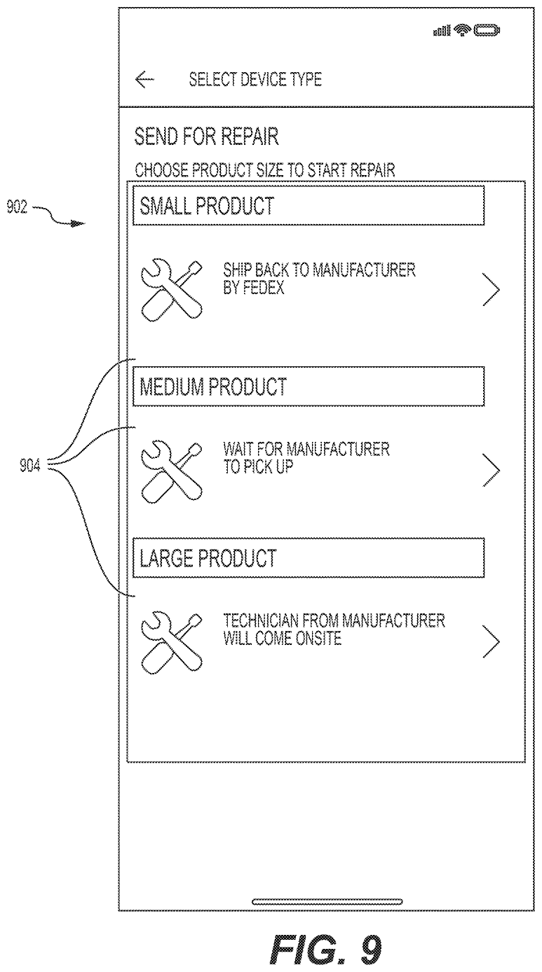

In a preferred embodiment, the end-user 102 is directed to select a product size on product size screen 902 as depicted in FIG. 9. Selection options 904 may include small products, medium products, or large products. Generally, a small product is a medical device 140 that can be shipped using standard shipping methods such as FedEx, USPS, UPS, etc. Medium products are medical devices 140 that can be shipped but may require an on-site pickup due to dimensions or weight. Large products are generally medical devices 140 that cannot be shipped due to their delicacy, size, or if they are installed. In a preferred embodiment, the product type and/or product size determines a predetermined set of capture viewpoints and ROI templates used by the scanning and fault classification process.

In a preferred embodiment, when a product type is selected, mobile application 104 loads product-type-specific capture guidance including at least one ROI template and a predetermined set of viewpoint prompts, and machine-enforces the capture guidance by rejecting images that fail ROI coverage and objective image-quality thresholds, as described with respect to FIG. 2.

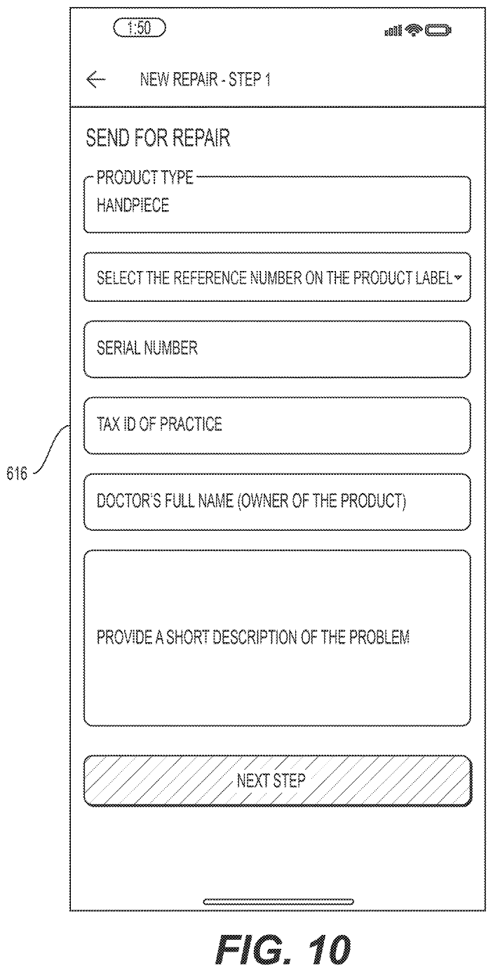

The end-user 102 is then prompted to enter additional product information on product information screen 616. An example product information screen 616 is depicted in FIG. 10. The additional product information may include the product's reference number, serial number, tax ID, the name of the owner or operator of the product, and a short description of the repair issue. In a preferred embodiment, if a fault classification has already been determined by AI module 132, the selected fault classification identifier and confidence value are automatically associated with the repair request and stored in association with the repair order identifier.

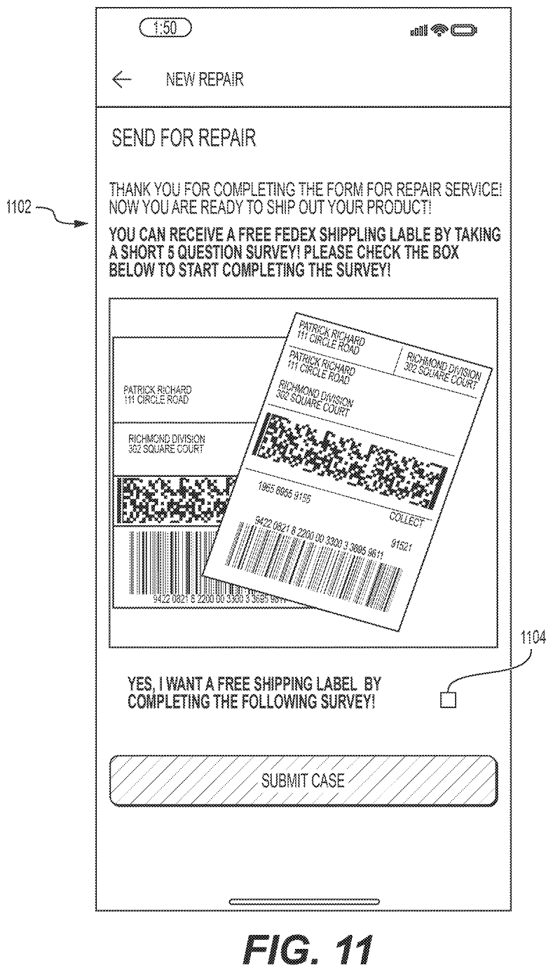

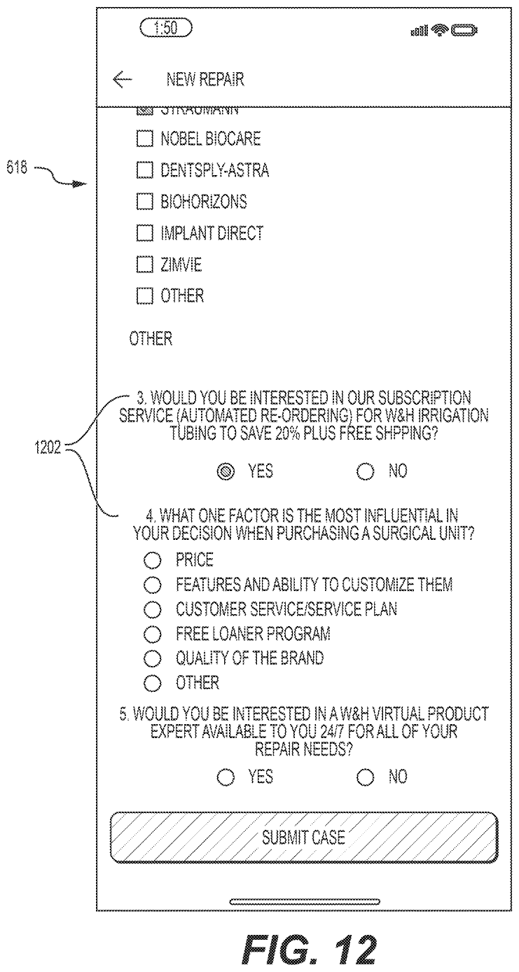

If the medical device 140 is a small product that can be shipped, the end-user 102 may be provided with a shipping option screen 1102 as depicted in FIG. 11 informing them that they can receive free shipping by filling out a survey. If the end-user 102 selects the check box 1104, the mobile application 104 displays survey screen 618. Example survey screen 618 generated by customer data collection system 118 is depicted in FIG. 12 listing questions 1202.

In a preferred embodiment, each product stored in error and product database 136 is associated with a particular repair location for that item. The repair location may be a third-party repair service or the manufacturer's own repair service. The manufacturer can select their preferred repair location for each of their products. For example, a manufacturer may choose to have products of a first type repaired by a particular third-party repair shop whereas products of a second type are shipped directly to the manufacturer. Because the repair location information is stored ahead for each medical device, the repair location address can automatically be pulled by repair management system 100. The end-user 102 does not have to determine the address. The end-user is only required to affix a generated shipping label to the medical device packaging as it already has the correct address specified in advance by the manufacturer.

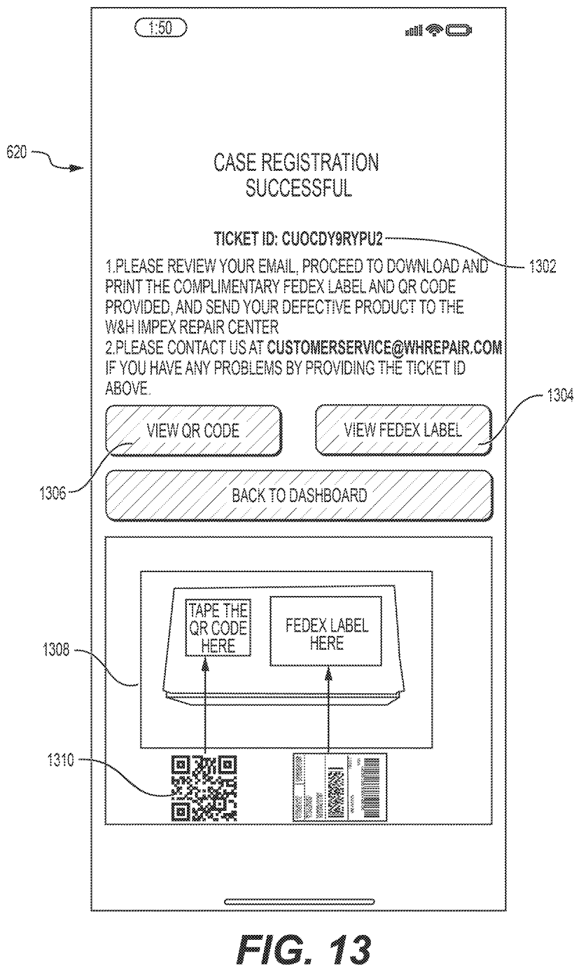

After the end-user 102 completes the survey screen 618, a submission screen 620 is displayed to the end-user 102. An example submission screen 620 is depicted in FIG. 13. The end-user 102 is provided with a confirmation number/ticket id 1302 which is used to uniquely identify each repair request and which corresponds to a server-generated repair order identifier stored by repair system 114. The confirmation number/ticket id 1302 is stored in association with the repair request information gathered. The tracking number for the shipping label is stored in association with the confirmation number/ticket id 1302. Selecting shipping label option 1304 prompts shipping label generator and tracker 120 to produce a shipping label for the end-user 102.

A machine-readable code 1310 is also generated by selecting code button 1306. In a preferred embodiment, the machine-readable code 1310 is a QR code that encodes information related to the repair including at least the confirmation number/ticket id 1302, a product identifier, and a shipment tracking identifier. In a preferred embodiment, the machine-readable code 1310 further includes an integrity value comprising at least one of a checksum or a cryptographic signature, enabling repair system 114 or manufacturer portal 112 to validate that the encoded information has not been modified. The encoded information may optionally be encrypted when sensitive personal information is included. An instruction image or video 1308 may be provided on submission screen 620 showing how the shipping label and machine-readable code should be attached to the packaging.

In a preferred embodiment, the integrity value is computed by repair system 114 based on the encoded fields of the machine-readable code 1310 and is validated upon scanning at a receiving facility. If validation fails, the received package is flagged for manual inspection and the associated repair case is placed into an exception state.

In a preferred embodiment, the machine-readable code 1310 is generated by repair system 114 after a repair order record is created and is transmitted to mobile application 104 for display and printing.

In a preferred embodiment, the repair order record includes a state version value that is incremented only by repair system 114 when a server-side workflow transition is permitted.

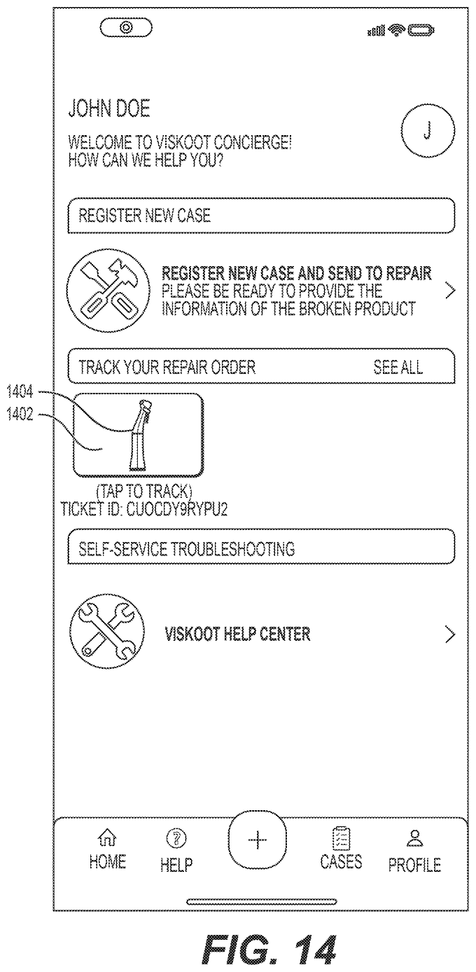

The repair order 1402 is then added to dashboard 608 as depicted in FIG. 14. The repair order 1402 preferably includes an image 1404 of the medical device 140 being repaired and the confirmation number/ticket id 1302. In an alternative embodiment, dashboard 608 also displays a current workflow state and/or a state version value for the repair order 1402. The end-user 102 can select repair order 1402 to view case milestones associated with repair order 1402.

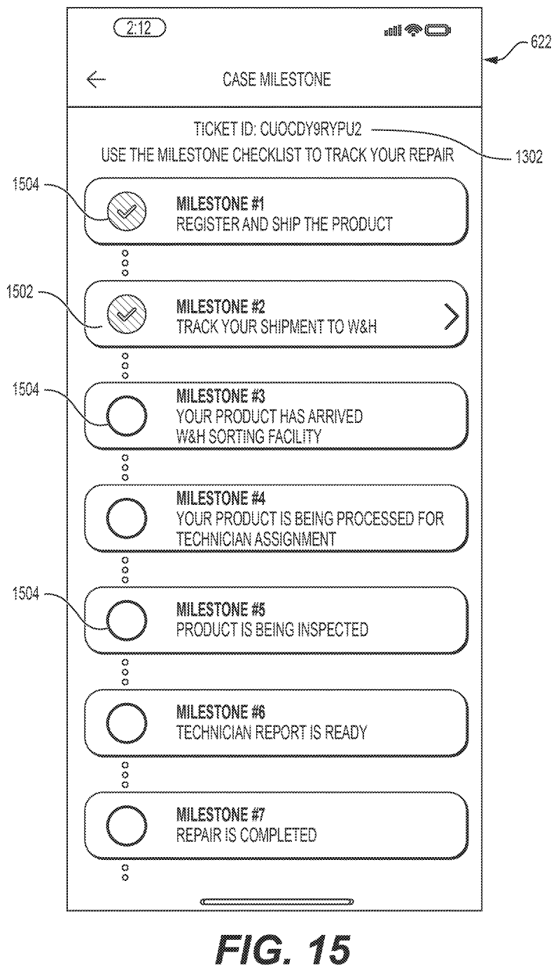

FIG. 15 depicts an example milestone screen 622 showing the status of the repair process for repair order 1402. In a preferred embodiment, milestones displayed on milestone screen 622 are derived from a machine-defined workflow implemented by repair update and tracking system 130 on repair system 114. Shipment tracking 624 may be presented from milestone screen 622 at one or more workflow stages to allow end-user 102 to monitor shipment progress and case progress. Mobile application 104 receives workflow updates as state-transition events and updates milestone indicators only upon validating the events.

As each milestone 1502 in the repair process is completed, an icon 1504 associated with the milestone 1502 is changed to reflect completion. In a preferred embodiment, the icon update occurs only after mobile application 104 receives a validated state-transition event including the repair order identifier, a state version value, and an event nonce. In a preferred embodiment, when a shipment arrives at the repair facility 110, the QR code 1310 is scanned and repair system 114 validates the integrity value and updates the workflow state to “received” when a corresponding transition rule is satisfied. This triggers transmission of a state-transition event to mobile application 104, causing the icon 1504 for a corresponding milestone 1502 to be updated. Rules for triggering each milestone 1502 are configurable by a technician or manufacturer and are controlled by repair update and tracking system 130 using a server-side state transition table.

In a preferred embodiment, mobile application 104 stores, for each repair order 1402, a locally maintained current state version value and a record of one or more previously accepted event nonces. Upon receipt of a state-transition event payload, mobile application 104 validates that (i) the repair order identifier matches the locally stored identifier for the repair order 1402, (ii) the state version value is greater than the locally maintained current state version value, and (iii) the event nonce has not been previously accepted for the repair order 1402. When validation succeeds, mobile application 104 updates the locally maintained current state version value to the received state version value, records the received event nonce as accepted, and updates the milestone indicators.

In a preferred embodiment, selection of a milestone 1502 causes mobile application 104 to transmit a milestone detail request including the repair order identifier and the current state version value, and repair system 114 transmits milestone details only when the current state version value matches the repair order record.

In a preferred embodiment, the event nonce enables detection of replayed state-transition event payloads. Mobile application 104 rejects a received state-transition event payload when the event nonce indicates reuse of a previously accepted nonce for the repair order 1402, thereby preventing replay-based duplication or rollback of displayed milestone status.

No action is required by the end-user 102 until a “report ready” milestone 1502 is activated which indicates that a repair report is ready. In a preferred embodiment, when the repair report is ready, repair system 114 transmits a state-transition event to mobile application 104 and triggers one or more notifications to the end-user 102.

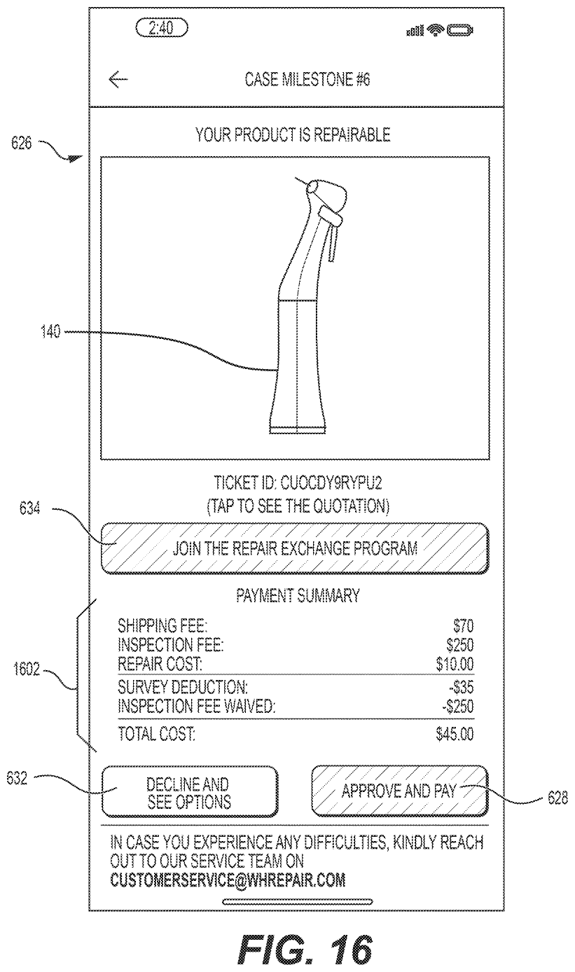

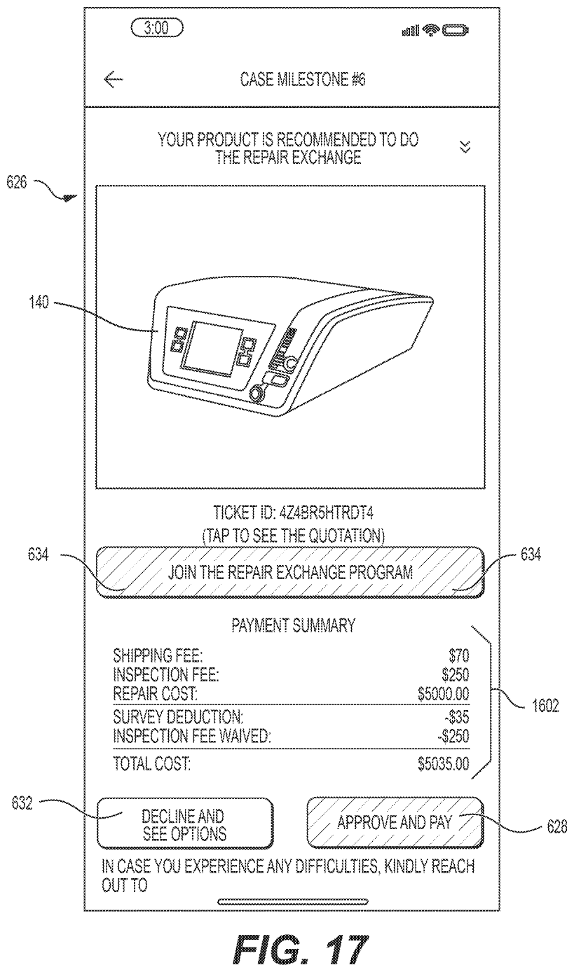

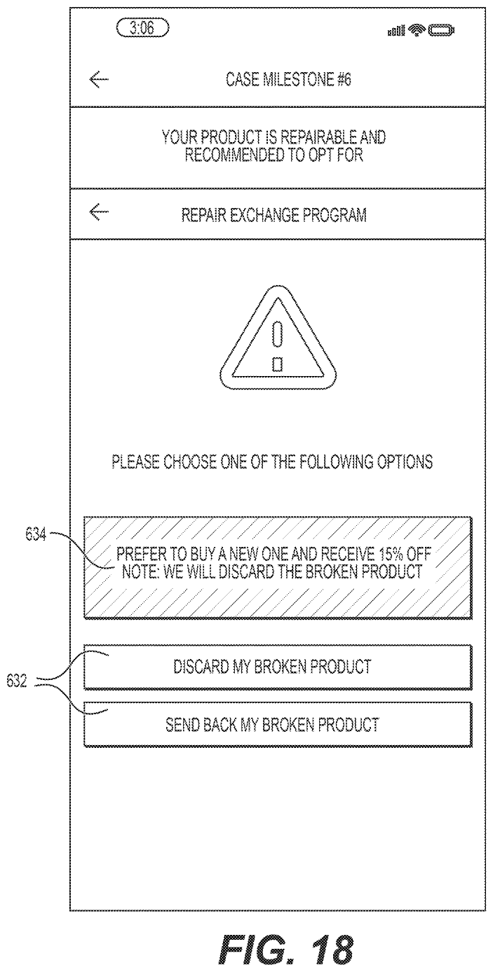

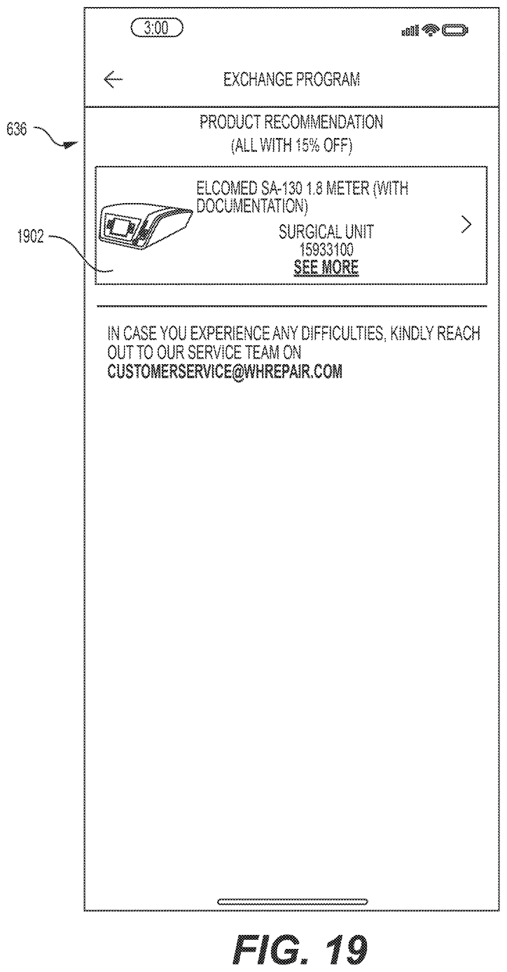

Selection of the “report ready” milestone 1502 causes a repair report screen 626 to be displayed. If the end-user 102 selects approved option 628 and proceeds with repair, a payment confirmation page 630 may be displayed after payment processing through financial transaction system 126. If the end-user 102 selects product exchange option 634, mobile application 104 may direct the end-user 102 to a recommended product list 636 and may provide a request discount code for the selected product 638. Example repair report screens 626 are depicted in FIGS. 16-19. If the medical device 140 can be repaired, the repair report screen 626 of FIG. 16 may be displayed and includes a payment summary section 1602. If the end-user 102 selects the approved option 628, the end-user 102 utilizes financial transaction system 126 to pay for the repairs. If the repair is declined, the end-user 102 can select decline option 632 and choose to have the medical device returned or destroyed.

The end-user can also choose product exchange option 634 which allows the end-user 102 to purchase a similar or replacement medical device, optionally at a discount. In a preferred embodiment, selecting product exchange option 634 initiates a replacement workflow on repair system 114 by creating a replacement order object associated with the repair case and transitioning the repair case to a replacement state.

Selecting product exchange option 634 directs the end-user 102 to a product recommendation page 636 listing products that are suitable as a replacement. In a preferred embodiment, replacement selection is filtered based on a compatibility signature for the medical device 140 that includes one or more technical attributes such as a model identifier, revision identifier, and/or an interface profile hash. The end-user 102 can select one of the displayed recommendations 1902 and pay for the purchase using financial transaction system 126.

In certain instances, the repair cost may be comparable to or greater than the cost of a completely new or refurbished product. In a preferred embodiment, repair system 114 computes a replacement evaluation based on repair resources captured as machine-recorded events (e.g., diagnostic time, parts identifiers, technician task code identifiers) and compares a computed repair cost to a replacement threshold. If the threshold is satisfied, repair system 114 transitions the repair case to a replacement workflow state and presents a screen indicating that it is recommended to join the repair exchange program, while still allowing the end-user 102 to approve repair.

The repair report screen 626 may also indicate that the product is not repairable. In a preferred embodiment, when a “not repairable” classification is determined with confidence satisfying a confidence threshold, repair system 114 initiates a replacement workflow by generating a replacement order object and transitioning the repair case to a replacement state. The end-user 102 can select product exchange option 634 to buy a new product, or select decline option 632 and choose to have the product returned or destroyed. If the end-user 102 chooses to have the object returned, the end-user 102 is prompted to pay for return shipping using financial transaction system 126.

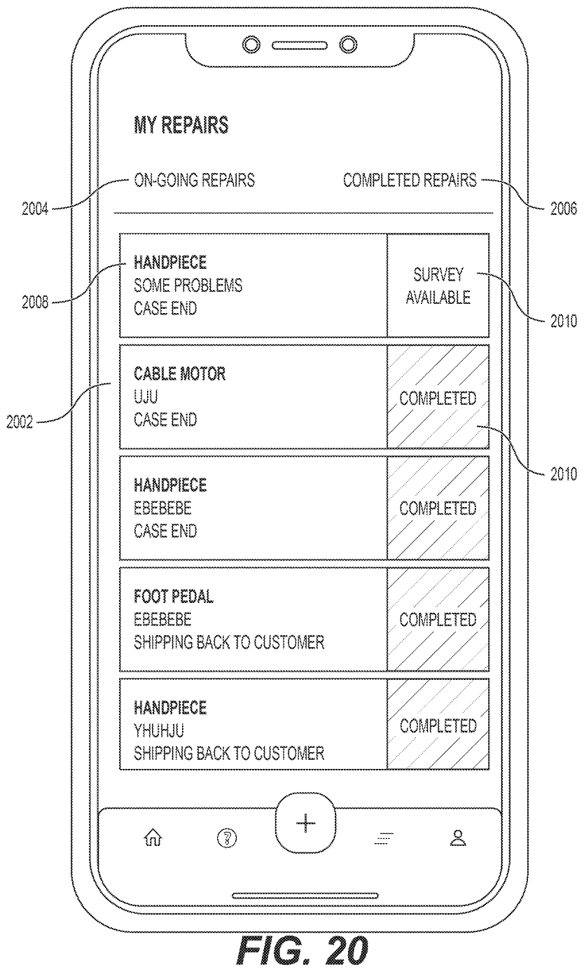

Returning to FIG. 7, if end-user 102 chooses case option 714 from dashboard 608, a listing 2002 of all repairs associated with the logged-in end-user 102 are displayed as depicted in FIG. 20. The end-user 102 can toggle the display by selecting the ongoing repairs option 2004 or the completed repairs option 2006. For each repair request, identifying information 2008 is provided adjacent to the most recent status 2010. In a preferred embodiment, the most recent status 2010 is updated solely in response to validated state-transition events received from repair system 114. The most recent status 2010 may also indicate that a survey 618 is available to the end-user 102 related to the repair.

### Manufacturer Portal 112

As previously discussed with reference to FIG. 1, each repair supplier 110 has access to manufacturer portal 112 that can be used to scan received repairs, track the status of repairs, and ship out completed repairs. In a preferred embodiment, manufacturer portal 112 operates as a privileged client of repair system 114 and is configured to submit workflow transition requests and technician updates, wherein repair system 114 enforces a machine-defined workflow comprising a plurality of states and a server-side state transition table. When a state transition is permitted, repair system 114 updates a repair order record, increments a state version value, and transmits a state-transition event (including the repair order identifier, state version value, and event nonce) to mobile application 104.

In a preferred embodiment, manufacturer portal 112 logs operational actions as machine-recorded events in association with a repair order record, including timestamps and one or more of scanned part identifiers, technician task code identifiers, and inspection outcomes.

In a preferred embodiment, repair system 114 rejects a workflow transition request that is not permitted by a corresponding transition rule in the server-side state transition table, thereby preventing inconsistent or out-of-order case status changes.

In a preferred embodiment, manufacturer portal 112 includes role-based access control such that only authorized roles can request particular workflow transitions (e.g., only supervisor role can assign technicians; only shipping role can transition to “shipped back”).

The main elements of manufacturer portal 112 are depicted in FIG. 21. Manufacturer portal 112 generally comprises monitor board 2102, receive shipment panel 2104, supervisor panel 2106, and technician panel 2108. Each user of manufacturer portal 112 can be assigned one or more designations or access levels which determine which features can be accessed. In a preferred embodiment, each panel is configured to create or request state transitions through repair system 114, and repair system 114 generates state-transition events upon permitted transitions for delivery to mobile application 104.

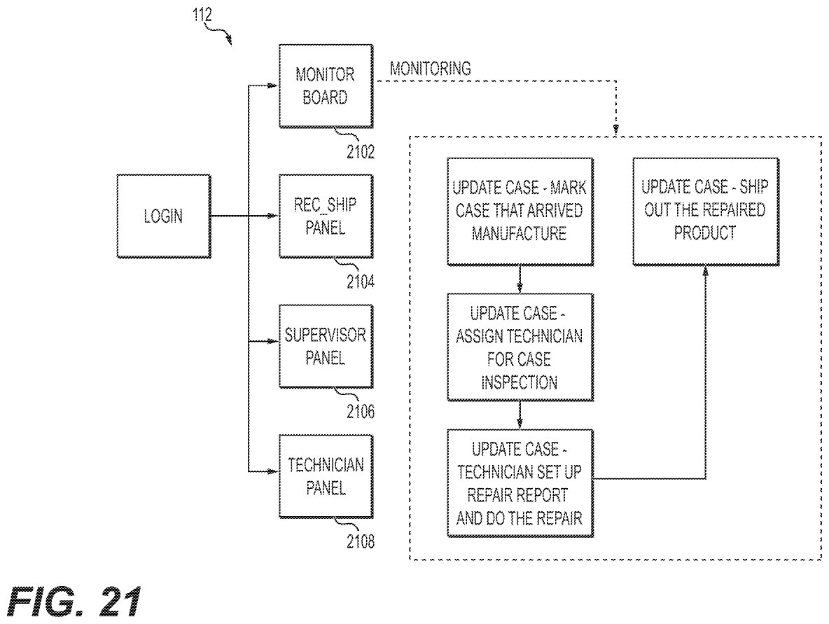

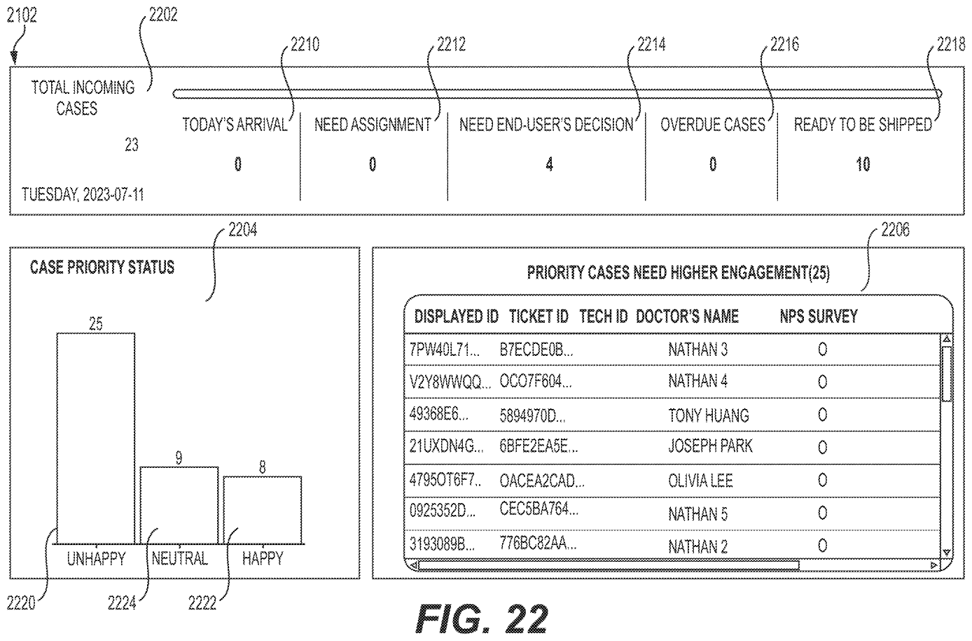

FIG. 22 depicts an example monitor board 2102 including case priority index 2204 and priority cases 2206.

Total Incoming Cases 2202 indicates the number of repair cases currently being sent to the shipping team.

Today's Arrival 2210 shows the cases that have arrived at the repair supplier 110.

Need Assignment 2212 are the cases that have not been assigned to a technician yet and are now waiting to be assigned by the supervisor.

Waiting for End-user Decision 2214 includes cases where the technician has sent the repair report to the end-user 102 and is awaiting their decision.

Overdue Cases 2216 indicates cases that have exceeded the estimated repair or inspection time of 24 hours.

Ready to be Shipped 2218 displays cases that have been repaired or returned and are ready to be shipped out by the shipment team.

To help upper management and the whole team quickly grasp the sentiment of each case, different colors may be used to indicate the urgency of each case based on end-users'feedback that they provide during their case submission. Red may be used to represent unhappy end-users 2220 who are disengaged with the medical device brand. These end-users 2220 can be highly prioritized and addressed immediately with a fast turnaround time. Green may be used to represent strongly satisfied end-users 2222 who are fully engaged with the medical device brand. Yellow may be used to represent neutral end-users 2224 who indicated neither strongly satisfied nor strongly dissatisfied feedback.

The case priority index 2204 shows the number of repairs falling into each of the different categories. It should be obvious that the number of end-user categories and/or the display method used to represent each category can be varied as needed by each repair supplier 110.

Priority cases 2206 provides a listing of all cases marked from unhappy end-users 2220. These cases require immediate attention as end-users 2220 are unhappy or have urgent repair needs. Priority cases 2206 may display information including case ID, assigned technician, doctor's name, NPS survey result, and the current status.

In a preferred embodiment, urgency indicators and case prioritization inputs are stored in association with the repair order record as structured fields and are used to control assignment recommendations and notification rules, while workflow state transitions remain governed by the server-side state transition table.

In an alternative embodiment, monitor board 2102 displays a state version value or last event timestamp per case to allow supervisors to quickly detect stale or delayed updates.

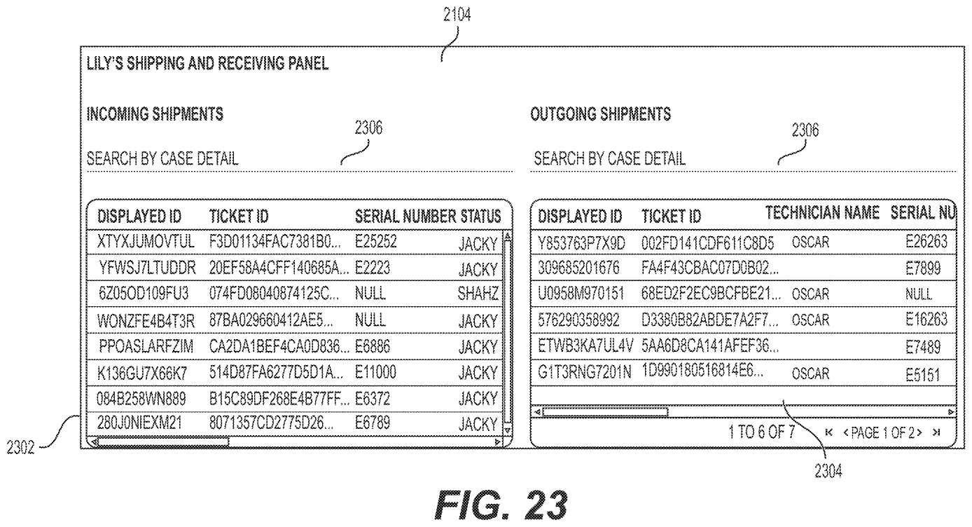

FIG. 23 depicts a sample receive shipment panel 2104. In a preferred embodiment, each member designated as mailroom or shipping has access to receive shipment panel 2104 after being authenticated. The receive shipment panel 2104 is divided into two main sections, designed to provide an overview of both incoming and outgoing repair cases, and includes search and modification features.

Incoming shipments section 2302 provides an organized list of all incoming cases destined for the repair supplier 110 and displays corresponding statuses. Entries may be color coded according to urgency based on end-users' feedback provided during their case submission.

The outgoing shipment section 2304 is similar to the incoming shipment section 2302 but provides information on cases that have been shipped from the repair supplier 110. The incoming shipment section 2302 and outgoing shipment section 2304 also comprise search field 2306 used to locate specific cases by typing any identifying information such as confirmation number/ticket id 1302, end-user name, etc.

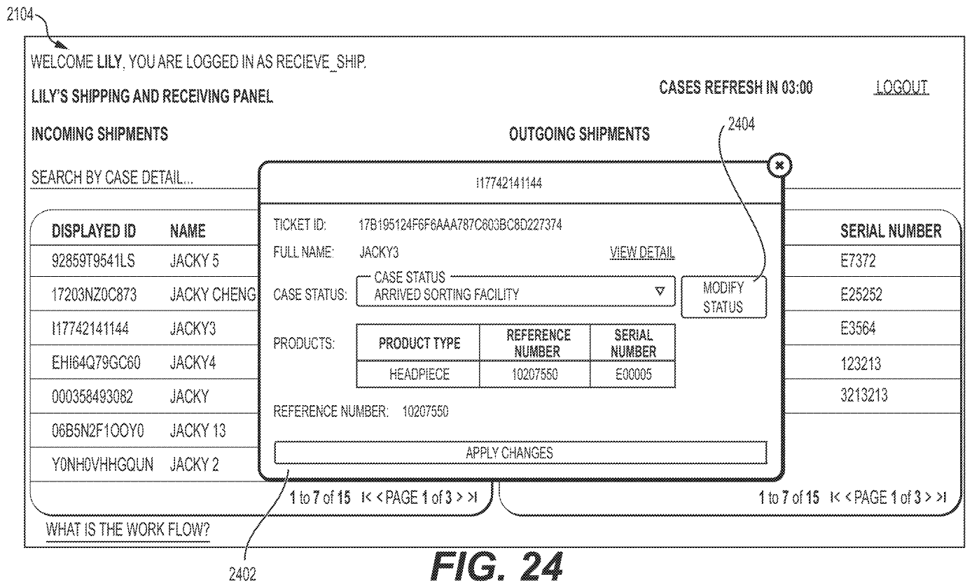

Any entry can be selected to produce a status screen 2402 for the selected repair order 1402 as depicted in FIG. 24. After the status is updated using the modify status button 2404, manufacturer portal 112 submits a state transition request to repair system 114. Repair system 114 verifies whether the transition is permitted by a transition rule in a server-side state transition table. When permitted, repair system 114 updates the repair order record, increments a state version value, and transmits a state-transition event to mobile application 104 to update milestone indicators.

If the status of any repair order 1402 is updated to “shipping back to end-user,” shipping label generator and tracker 120 generates a shipping label and adds the tracking number to the repair order record. Repair system 114 generates and transmits a state-transition event including an event nonce and updated state version value, which triggers mobile application 104 to update a corresponding milestone indicator.

When a package is received, manufacturer portal 112 scans machine-readable code 1310 and transmits decoded fields to repair system 114.

In a preferred embodiment, machine-readable code 1310 includes an integrity value comprising at least one of a checksum or cryptographic signature, and repair system 114 validates the integrity value prior to permitting a “received” transition.

If integrity validation fails or the decoded repair order identifier does not match a stored repair order record, repair system 114 flags the case into an exception state and manufacturer portal 112 displays a prompt for manual inspection.

Upon successful validation and receipt verification, repair system 114 advances the repair order record to a “received” workflow state and emits a state-transition event that is consumed by mobile application 104.

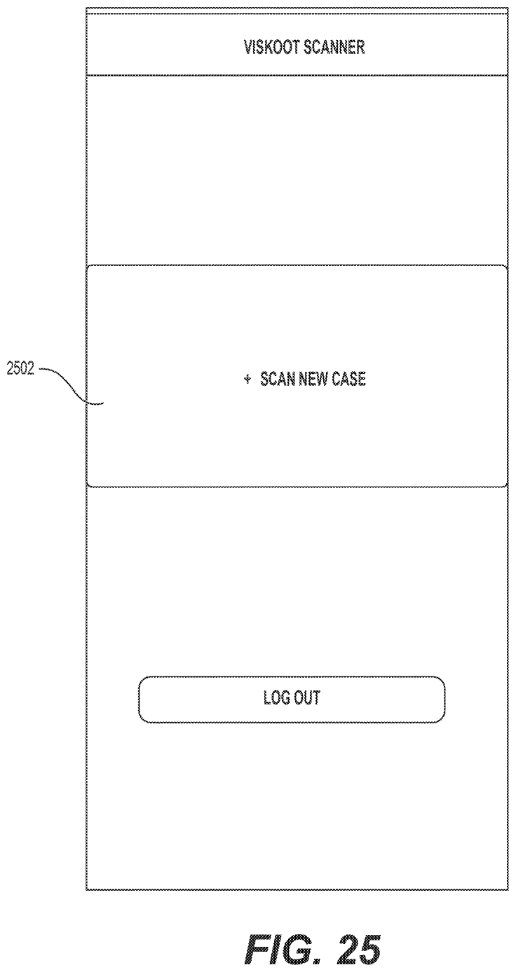

As products arrive at the repair supplier 110, machine-readable code 1310 affixed to the packaging by end-user 102 can be scanned by selecting scan new case button 2502 as depicted in FIG. 25. The scanning may be performed using dedicated hardware (e.g., 1D/2D scanner) or a device capable of imaging and decoding machine-readable codes. In a preferred embodiment, manufacturer portal 112 transmits decoded fields, including at least a repair order identifier, product identifier, and shipment tracking identifier, to repair system 114 for validation and receipt verification.

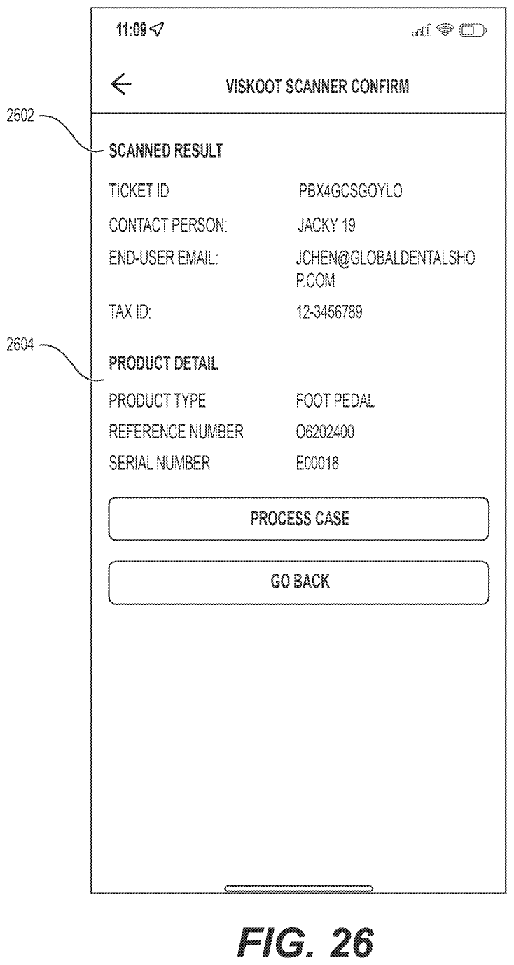

In a preferred embodiment, decoded information 2602 is displayed next to product detail information 2604 as depicted in FIG. 26. Repair system 114 validates the integrity value and verifies the repair order identifier against a stored repair order record prior to permitting a workflow transition to “received.” The repair order 1402 may automatically be assigned to an available technician according to predefined rules and/or availability, or manually assigned by a supervisor.

In a preferred embodiment, automatic assignment uses a rules engine that considers at least technician availability, product type, required certification, and case priority fields.

In a preferred embodiment, manufacturer portal 112 stores a scan timestamp and receiving operator identifier as a machine-recorded event in association with the repair order record.

In a preferred embodiment, a scan action triggers repair system 114 to generate a state-transition event including an event nonce and updated state version value.

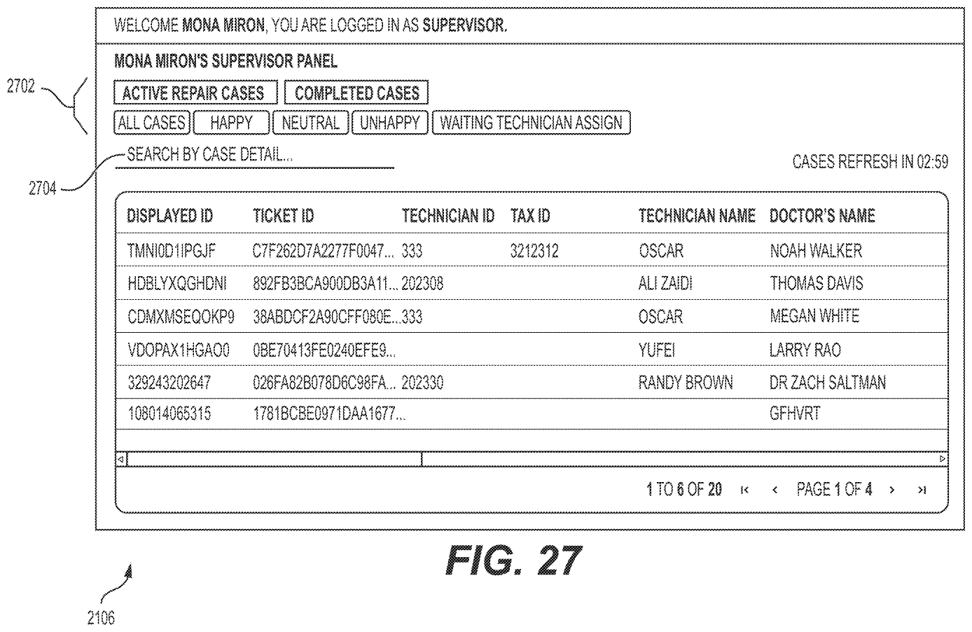

FIG. 27 depicts an example supervisor panel 2106. Supervisor panel 2106 provides supervisors with real-time insight of active repairs and completed cases. This allows for effective resource allocation and ensures a smooth workflow throughout the case management process. In addition, search function 2704 enhances efficiency by locating specific cases.

The supervisor panel 2106 includes a plurality of filters 2702 that can be used to limit the displayed results. For example, a “waiting technician assignment” filter 2702 can be used to see remaining cases that were not assigned to a technician.

To help supervisors quickly grasp the sentiment of each repair order 1402, different colors are used to indicate the urgency of each case based on end-users' feedback that they provide during their case submission.

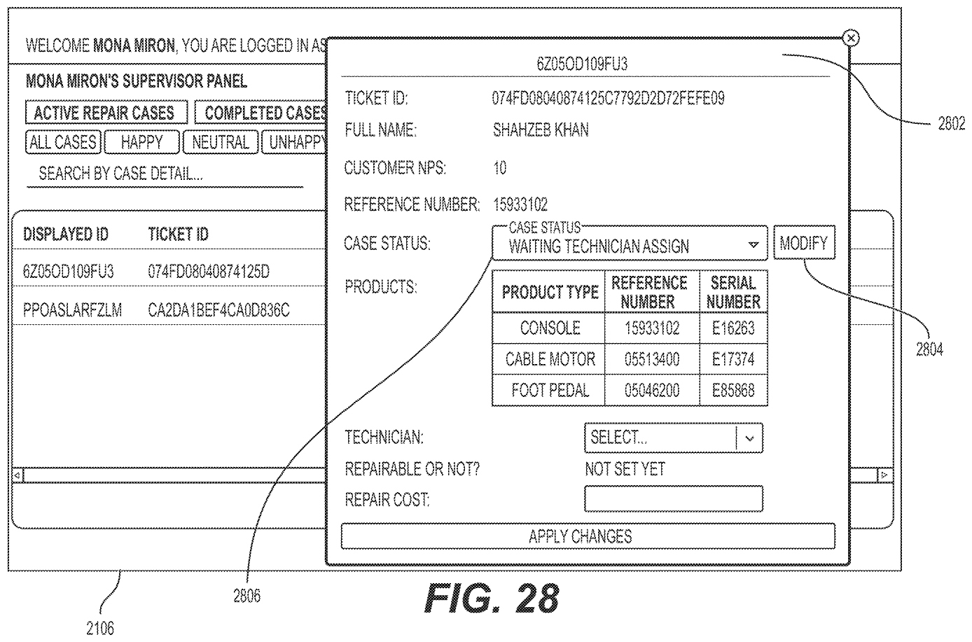

By clicking on any repair order 1402, additional information 2802 about the repair order 1402 is displayed to the supervisor as depicted in FIG. 28. The supervisor can request a case status change 2806 (e.g., to “inspecting”) and choose a technician by selecting the modify selection 2804. In a preferred embodiment, the requested status change and assignment are transmitted to repair system 114, which permits the transition only if a corresponding transition rule is satisfied. Upon a permitted transition, repair system 114 updates the repair order record, increments a state version value, logs the assignment as a machine-recorded event, and transmits a state-transition event to mobile application 104.

In a preferred embodiment, repair system 114 rejects an “inspecting” transition when the case has not yet been verified as “received,” thereby preventing out-of-order workflow state changes.

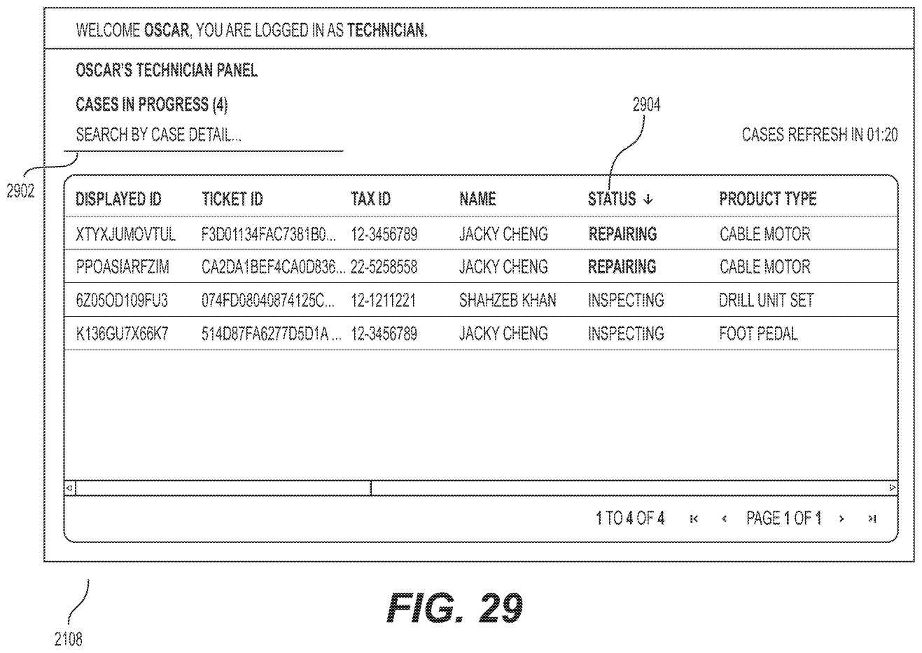

FIG. 29 depicts an example technician panel 2108. Each technician at the repair supplier 110 is provided with their own technician panel 2108 which only lists their currently active cases. If a technician marks a repair order 1402 as “ready for shipping,” the repair order is removed from the technician panel 2108 and moved to the receive shipment panel 2104.

Technician panel 2108 shows cases in progress and cases needing a response. The status of each case is indicated in status column 2904. A search function 2902 is provided to allow the technician to find certain cases if the list is long.

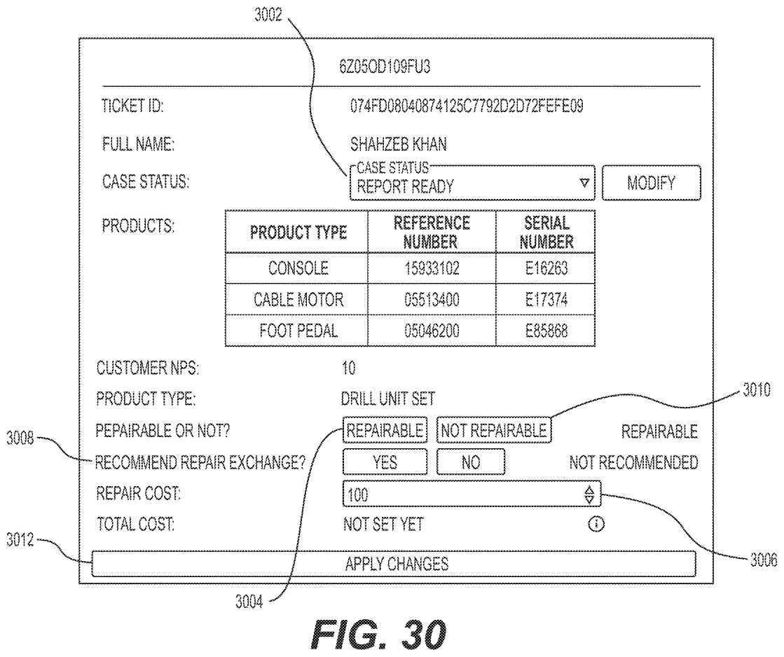

After cases are added to the technician panel 2108 by a supervisor or automatically, they are assigned an inspecting status. After inspecting the product and preparing an inspection report, the technician can select the case and update the case status 3002 to “report ready” as depicted in FIG. 30. If the product is repairable, the technician selects repairable option 3004 and fills out repair cost 3006 and/or itemized repair resources based on the quotation. In a preferred embodiment, repair resources are captured as machine-recorded events in the repair order record, including timestamps and one or more of diagnostic time, scanned part identifiers, and logged technician task code identifiers. The technician can choose whether to recommend the repair exchange program 3008 to the end-user 102. If the product is not repairable, the technician selects not repairable option 3010. Selecting apply changes 3012 submits a state transition request to repair system 114, and when permitted, repair system 114 updates the workflow state, increments a state version value, and triggers the “report ready” milestone on mobile application 104.

Once the end-user 102 makes a final decision to proceed with repairs and pays the repair fee, repair system 114 transitions the case to a “repairing” workflow state and transmits a corresponding state-transition event to mobile application 104 and manufacturer portal 112. The technician can then begin the repair process. After finishing the repair, the technician updates the case status 3002 to “finish repairing” and clicks apply changes 3012. When permitted by the server-side transition rules, the case is advanced to a “waiting for ship out” state and displayed to the shipping department.

In a preferred embodiment, repair system 114 computes a repair cost based on machine-recorded events including at least one of diagnostic time, scanned part identifiers, or technician task code identifiers, and compares the computed repair cost to a replacement cost threshold.

In a preferred embodiment, when the computed repair cost satisfies the replacement cost threshold, repair system 114 automatically transitions the repair order record to a replacement workflow state and generates a replacement order object associated with the repair case.

In a preferred embodiment, when replacement workflow is initiated, repair system 114 transmits a state-transition event to mobile application 104 that causes product exchange option 634 and replacement screens to be enabled.

FIG. 31 depicts a product recommendation feature 636. The product recommendation feature 636 may be applied when the end-user 102 elects to participate in a product exchange program, such as when repair is not possible or when the end-user 102 does not wish to proceed with a repair. In such cases, repair system 114 selects one or more replacement products for display on product recommendation page 636. In a preferred embodiment, replacement selection is based on the original product and may include use of a compatibility signature associated with the original product, the compatibility signature including one or more technical attributes such as a model identifier, a revision identifier, and/or an interface profile hash. The interface profile hash may be computed from one or more device interface attributes captured by mobile application 104 and/or stored in product database 136. In some embodiments, the product recommendation may additionally be based at least in part on customer behavior data.

When the end-user 102 selects an exchange option and/or a recommended product, repair system 114 generates a discount identifier in step 3102 based on eligibility criteria including at least one of end-user status, warranty entitlement, repair status, purchase price, customer association, and/or other exchange-program criteria. In a preferred embodiment, repair system 114 verifies a machine-verifiable entitlement credential before issuing the discount identifier. The discount identifier may comprise a machine-readable token bound to at least the repair order identifier and an expiration time, and the token may be cryptographically signed. The discount identifier is automatically applied to the purchase price during checkout in step 3104. In one embodiment, the end-user 102 is redirected to an electronic commerce checkout interface with the discount applied to the selected replacement product.

In step 3106, information provided to the end-user 102 may include product information and other information used to complete the purchase transaction. Repair system 114 may create and store a replacement order object in association with the repair case. After payment, and in step 3108, repair system 114 transmits replacement order details to the manufacturer for fulfillment. The token may be rejected when the repair status does not match a replacement workflow state, when the token is expired, or when signature validation fails.

### Power Tool Repair

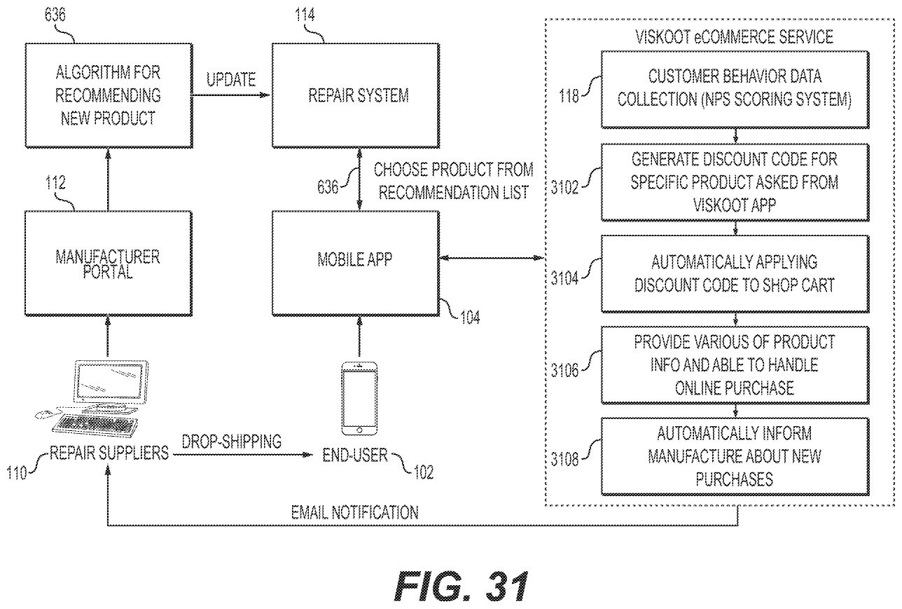

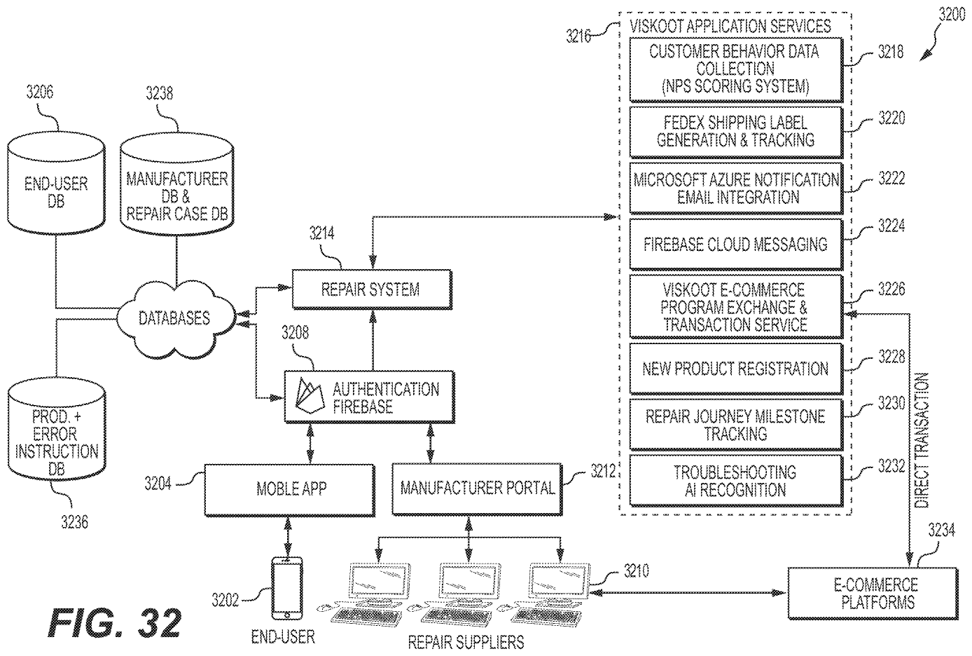

As previously discussed, repair management system 100 is configurable to handle repair and replacement of power tools for consumers. A repair tool management system 3200 is shown in FIG. 32. End-users 3202 access mobile application 3204 by downloading a dedicated application to a smartphone or tablet, or by using a web application through a browser. Each end-user 3202 registers with repair management system 3200 and identifying information is stored in user database 3206, enabling repair cases to be associated with the end-user 3202.

Firebase Authentication Service 3208 authenticates end-users 3202 using passwords, phone numbers, and log-in through identity providers. Multi-factor authentication, biometric authentication, or other secure authentication methods may be used.

Firebase Authentication Service 3208 authenticates end-users 3202 and repair suppliers 3210, and access policies may be enforced for different user roles.

Repair suppliers 3210 include third-party repair technicians and manufacturers. Repair suppliers 3210 access manufacturer portal 3212 via a dedicated application or browser-based interface.

### Mobile Application 3204 and Interface

Communication and interaction between mobile application 3204 and manufacturer portal 3212 is managed by repair system 3214. Further, repair system 3214 also controls application services 3216. Application services 3216 may include customer data collection system 3218, shipping label generator & tracker 3220, notification system 3222, messaging system 3224, financial transaction system 3226, product registration system 3228, repair update and tracking system 3230, and AI module 3232. Repair update and tracking system 3230 implements a machine-defined workflow comprising a plurality of states and a server-side state transition table, and emits state-transition events upon permitted transitions.

In some embodiments, mobile application 3204 may suggest new or replacement items to end-users 3202 if it is determined that repairs cannot be completed. End-users 3202 may utilize e-commerce platform 3234 for purchase of replacement products. Product and error instruction database 3236 may store product information and error instructions, and manufacturer database and repair case database 3238 may store manufacturer information, repair case information, and, in some embodiments, related or suitable replacement items associated with each power tool.

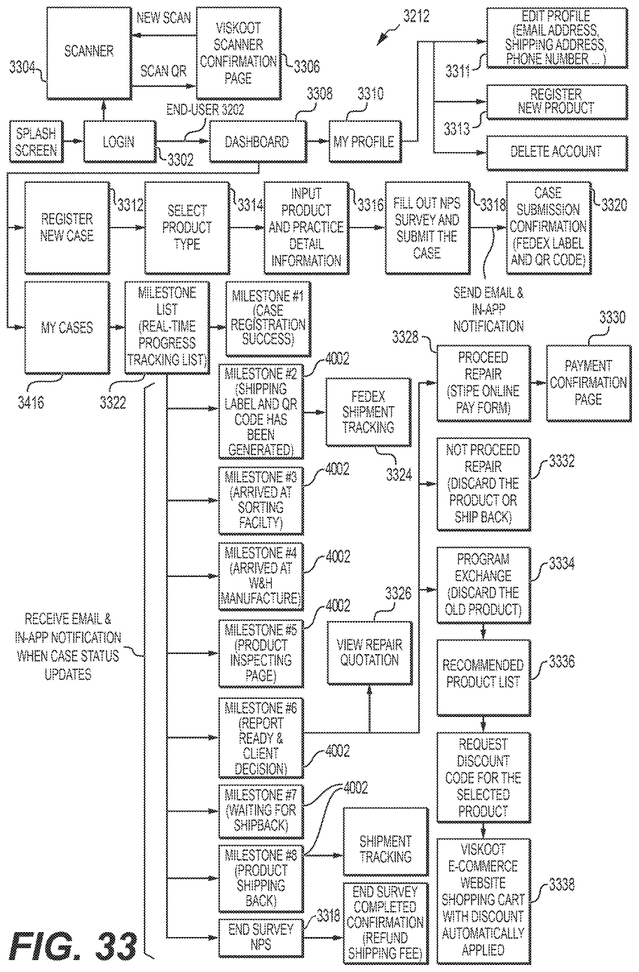

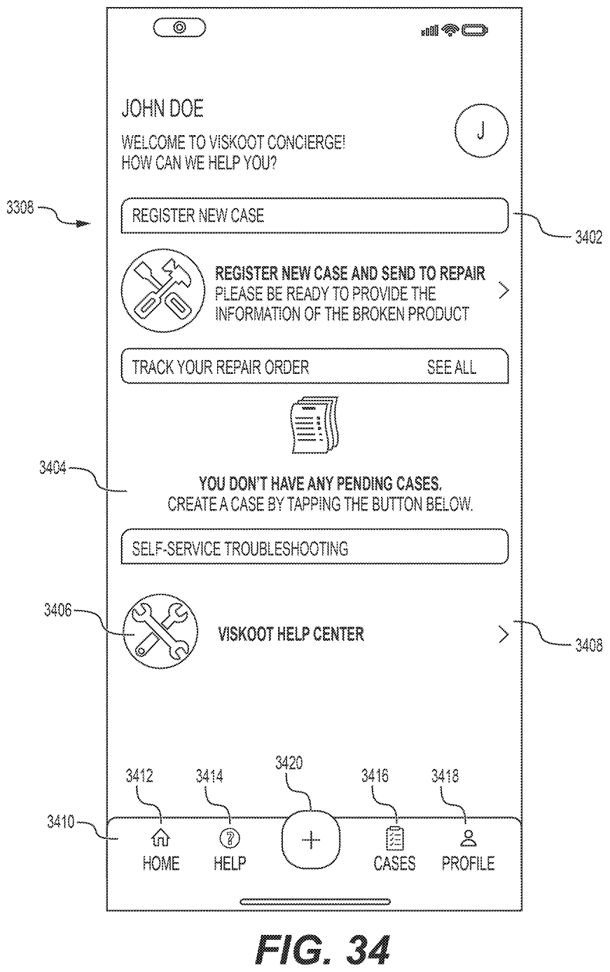

FIG. 33 depicts a flowchart of mobile application 3204. The mobile application 3204 allows the end-user 3202 to login in step 3302 and be authenticated through Firebase authentication service 3208. In some embodiments, the mobile application 3204 may further include scanner 3304 and Viskoot scanner confirmation page 3306. After the end-user 3202 is authenticated, dashboard 3308 is displayed to the end-user 3202 as depicted in FIG. 34. If the end-user 3202 selects profile option 3418, my profile screen 3310 is displayed. The end-user 3202 can select displayed fields in step 3311 to provide new or updated profile information. The end-user 3202 can also register new power tools in association with the account using register new product screen 3313. If the end-user 3202 selects plus option 3420 or register new case option 3402, a new repair request is initiated in step 3312. The end-user 3202 is prompted to select a product category in step 3314, to enter product and practice detail information in step 3316, to fill out NPS survey and submit the case in step 3318, and to receive case submission confirmation in step 3320. The end-user 3202 may access milestone list 3322, which includes a plurality of milestones 4002 corresponding to different steps of the repair process, and may access shipment tracking screen 3324 to track shipments associated with the repair. When the repair report is ready, repair report screen 3326 is displayed. If repair is approved, the end-user 3202 may select approve and pay option 3328 and confirmation page 3330 is displayed after payment. If the end-user 3202 does not wish to proceed with repair, the end-user 3202 may select decline and see options 3332. If the end-user 3202 selects product exchange option 3334, product recommendation page 3336 is displayed and the end-user may be directed to Viskoot e-commerce website shopping cart 3338 with a discount automatically applied.

Dashboard 3308 includes a tracking section 3404 that provides the end-user 3202 with a listing of active repair requests, and a help section 3406 that, when selected, directs the end-user 3202 to help center 3408. Help center 3408 may include frequently asked questions, contact information, and options to discuss issues with a live agent. Access menu 3410 is displayed on pages of mobile application 3204 and includes home 3412, help 3414, cases 3416, and profile 3418. Repair status displayed on dashboard 3308 and case screens updates only in response to validated state-transition events received from repair system 3214, each event including at least a repair order identifier, a state version value, and an event nonce.

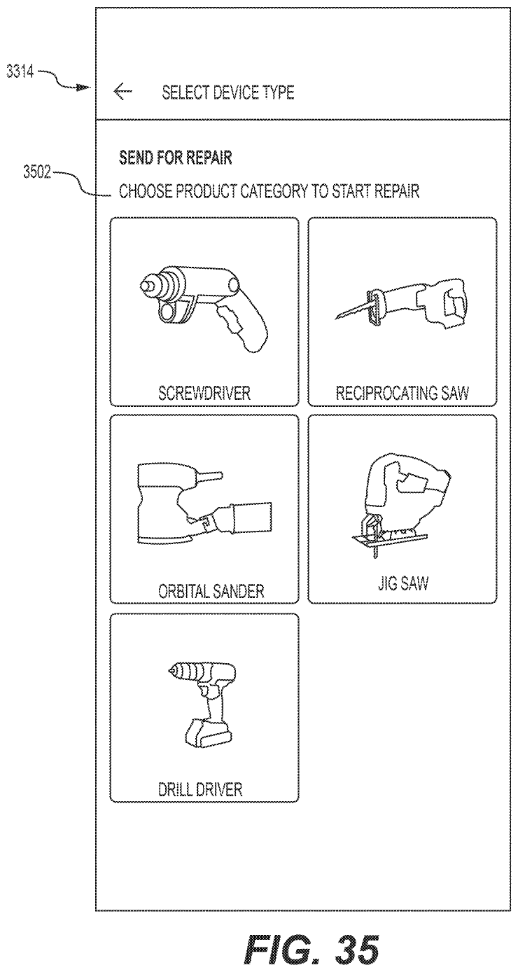

A new repair request is initiated via plus option 3420 or register new case option 3402. Select product type screen 3314 (FIG. 35) is displayed to select product category 3502. Product type selection controls capture guidance and repair routing.

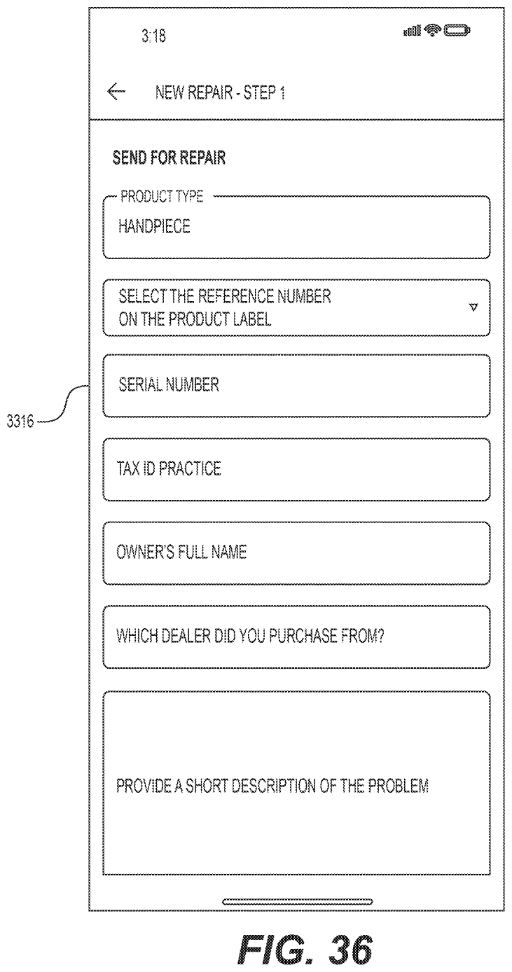

Product information screen 3316 (FIG. 36) collects reference number, serial number, tax ID, owner/operator identity, and a description of the issue.

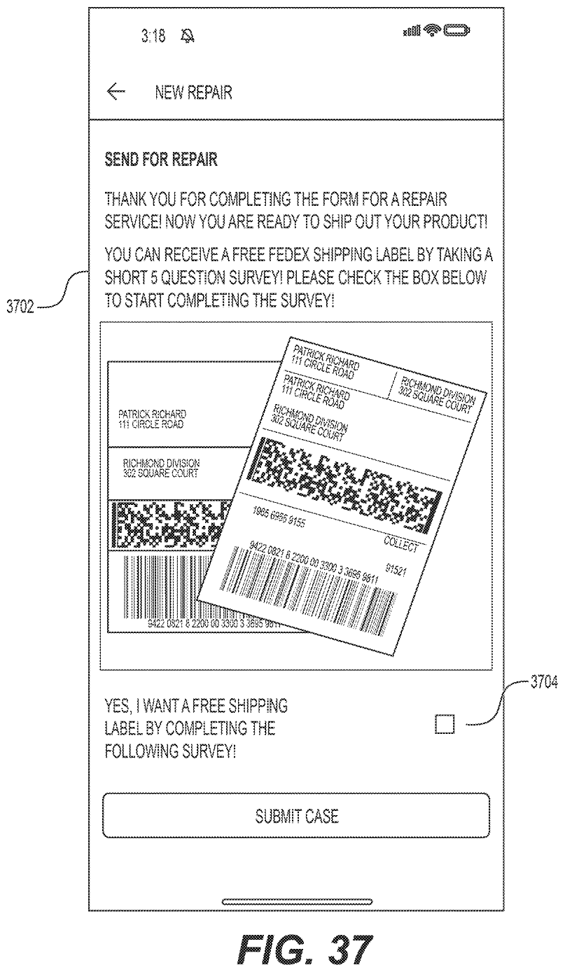

Shipping option screen 3702 (FIG. 37) offers free shipping upon completion of a survey and may include check box 3704. When the end-user 3202 selects check box 3704, survey screen 3318 is generated by customer data collection system 3218.

Each product stored in product and error instruction database 3236 is associated with a repair location selected by the manufacturer. The repair location may be a third-party repair service 3210 or a manufacturer's own repair service. Manufacturer database and repair case database 3238 may store manufacturer information, repair case information, and, in some embodiments, related or suitable replacement items associated with each power tool. The address is retrieved automatically by repair management system 3200 for shipping label generation.

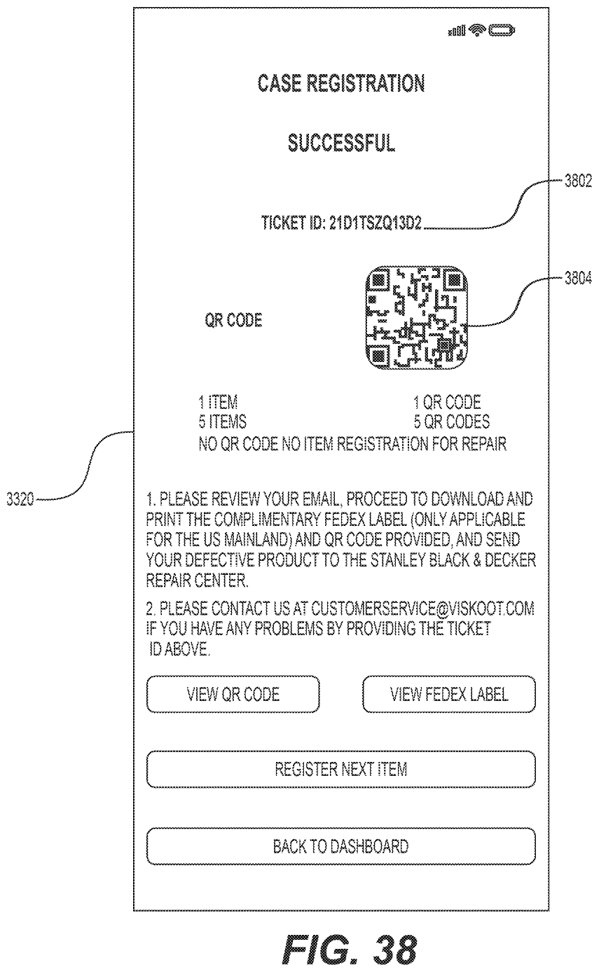

Submission screen 3320 (FIG. 38) displays Confirmation Number 3802 corresponding to a server-generated repair order identifier. A shipment tracking number is stored in association with Confirmation Number 3802.

Machine-readable code 3804 encodes at least Confirmation Number 3802, a product identifier, a shipment tracking identifier, and an integrity value comprising at least one of a checksum or cryptographic signature. The integrity value enables validation that encoded fields have not been modified.

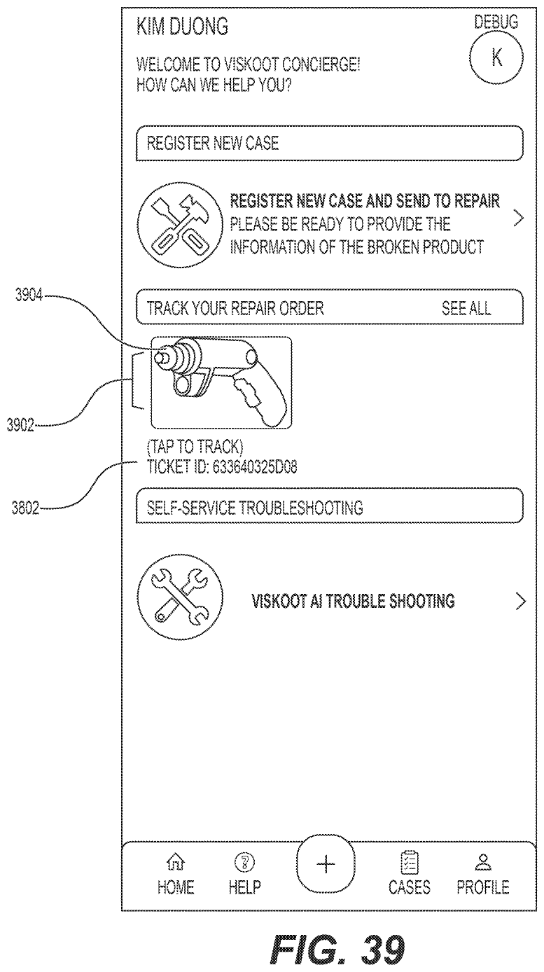

Repair order 3902 is added to dashboard 3308 (FIG. 39) and includes an image 3904 and/or Confirmation Number 3802.

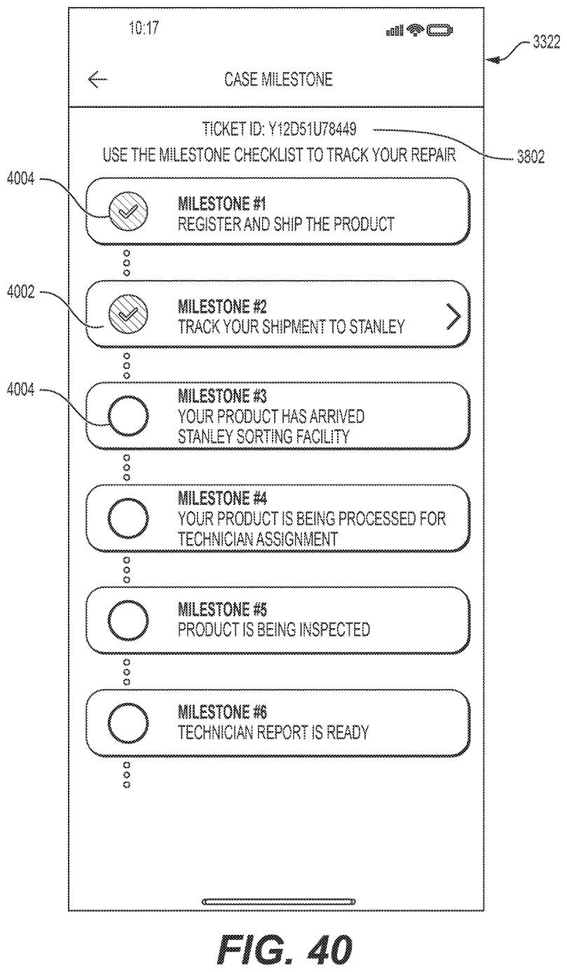

Milestone screen 3322 (FIG. 40) displays repair process status derived from the server-defined workflow. Each milestone 4002 corresponds to a different step of the repair process, and icon 4004 associated with each milestone 4002 changes to reflect completion, such as by addition of a check mark. Mobile application 3204 updates milestone indicators only upon validation of state-transition events including the state version value and event nonce.

Manufacturer portal 3212 requests workflow transitions. Repair system 3214 permits transitions only when the corresponding transition rule in the server-side transition table is satisfied, increments the state version value, and emits a state-transition event. When a shipment arrives, machine-readable code 3804 is scanned, integrity is validated, and the workflow advances to “received.”

End-user action is not required until “report ready” is activated. Repair system 3214 transmits a state-transition event and triggers notifications when end-user approval or replacement selection is needed.

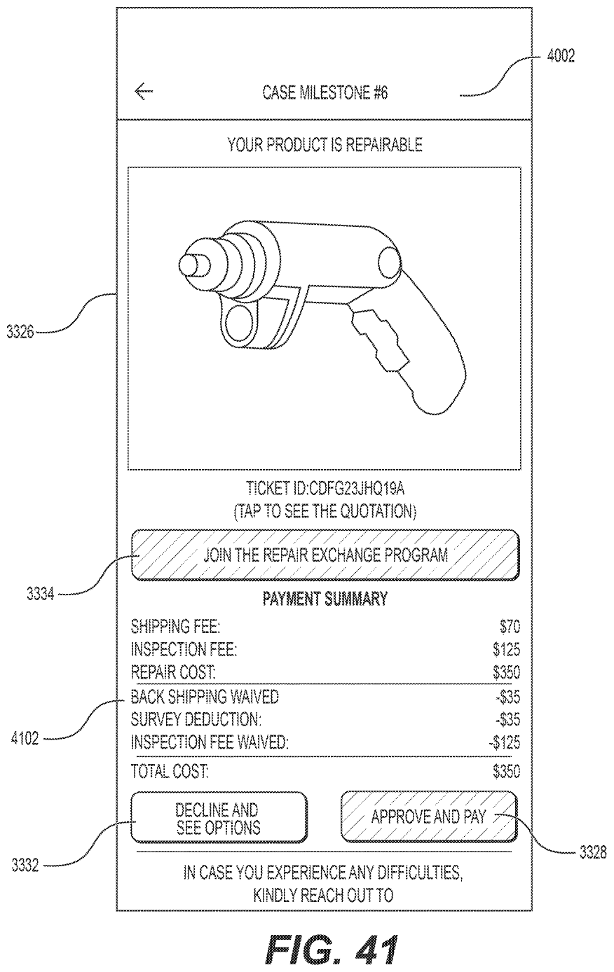

Repair report screens 3326 are shown in FIGS. 41-43. When milestone 4002 corresponding to the report-ready stage is activated, repair report screen 3326 is displayed. If repairable, the report provides repair cost and payment summary 4102. Approved repairs are paid through financial transaction system 3226 after the end-user 3202 selects approve and pay option 3328, and confirmation page 3330 is displayed. Declined repairs trigger return, destruction, or other alternate workflows after the end-user 3202 selects decline and see options 3332.

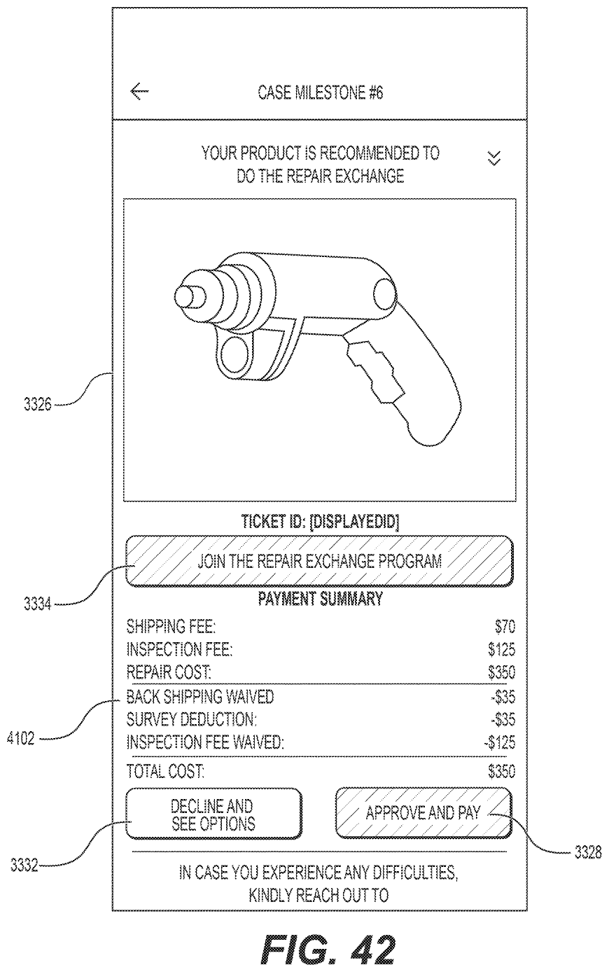

Product exchange option 3334 enables purchase of a replacement product without leaving the application. As shown in FIG. 42, approve and pay option 3328 and decline and see options 3332 may also be presented when the product is recommended for repair exchange.

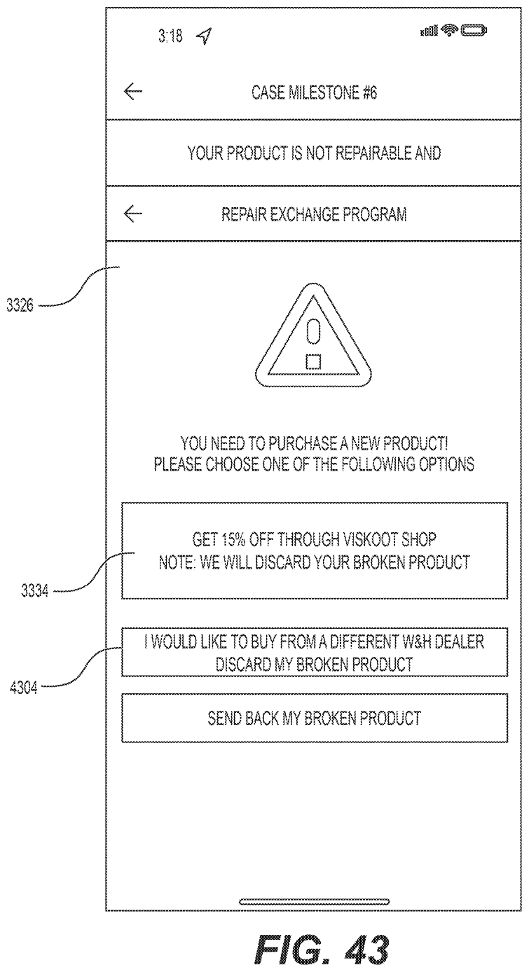

As shown in FIG. 43, different dealer option 4304 may be provided to allow the end-user 3202 to indicate a preference to purchase from a different dealer.

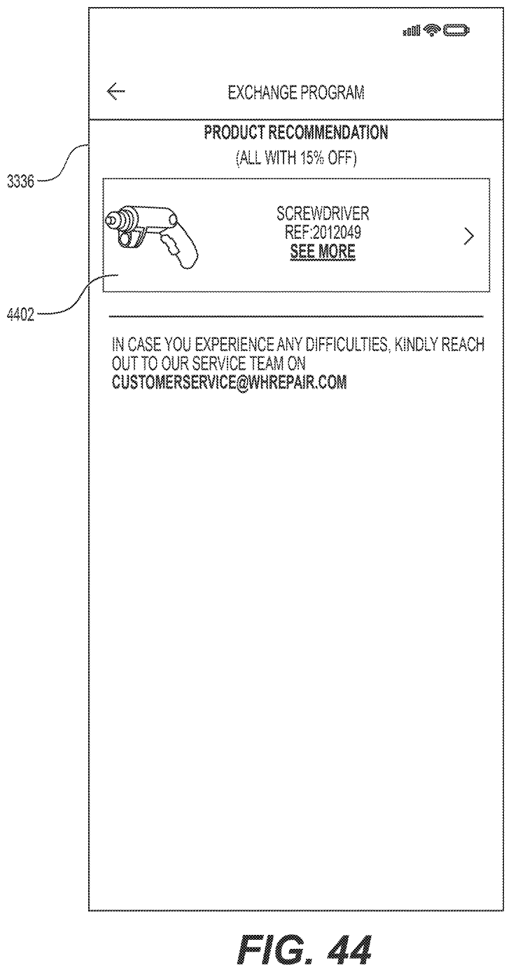

FIG. 44 depicts product recommendation page 3336 of an exchange program. The screen displays one or more recommended replacement products 4402, each recommendation including at least a product name and/or category (e.g., “screwdriver”), a reference identifier (e.g., “REF: #######”), and a selectable detail control (e.g., “SEE MORE”) enabling the end-user 3202 to view additional information for the recommendation. The page may also present an exchange incentive (e.g., a displayed discount such as “15% off”) and a support contact message for assistance.

In a preferred embodiment, selection of a recommended replacement product 4402 causes mobile application 3204 to transmit a replacement-selection request to repair system 3214 that includes at least a repair order identifier and a selected product identifier, and repair system 3214 creates or updates a replacement order object associated with the repair case and enables checkout through financial transaction system 3226.

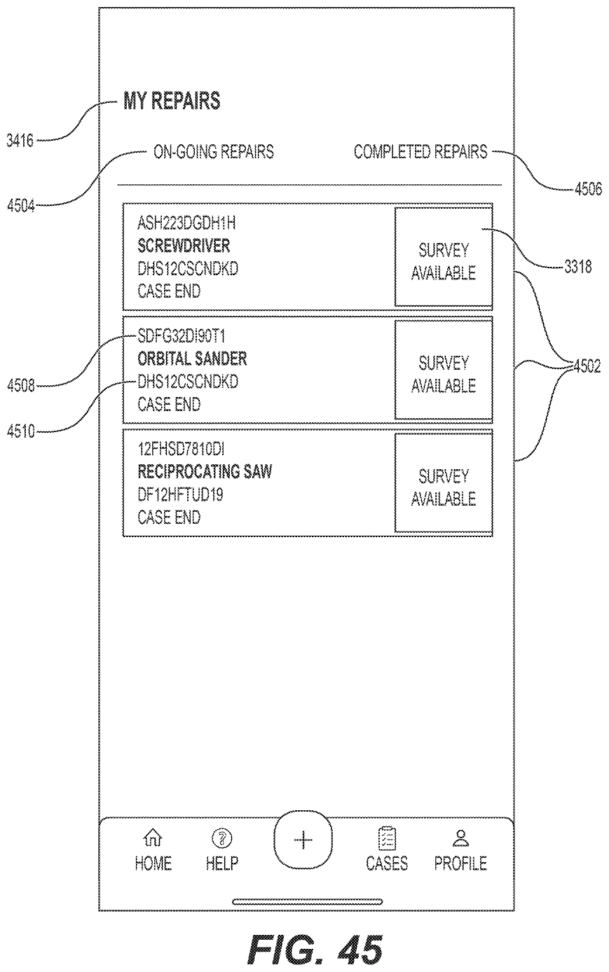

FIG. 45 depicts a cases listing screen (“MY REPAIRS”) showing an ongoing repairs view 4504 and a completed repairs view 4506. The screen displays a listing 4502 of repair cases, wherein each entry includes identifying information 4508 and a most recent status indicator 4510. The screen further displays a survey indicator (e.g., “SURVEY AVAILABLE”) associated with one or more cases, indicating that survey screen 3318 is available for the corresponding repair.

In a preferred embodiment, mobile application 3204 updates the most recent status indicator 4510 only in response to validated state-transition events received from repair system 3214, each validated event including at least a repair order identifier, a state version value, and an event nonce, thereby preventing stale or replayed status updates from being displayed.

### Manufacturer Portal 3212

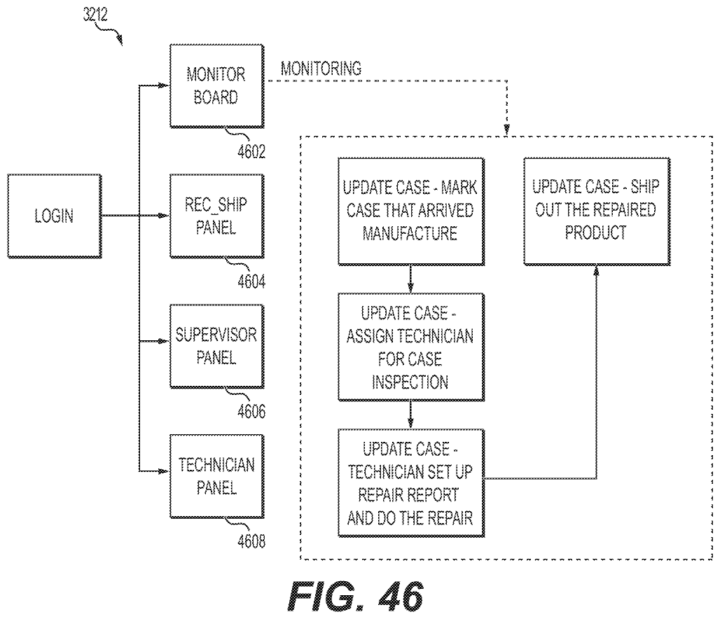

FIG. 46 depicts an operational overview of manufacturer portal 3212. A portal login enables access to a plurality of panels including monitor board 4602, receive shipment panel 4604, supervisor panel 4606, and technician panel 4608. The panels support operational actions including marking a case as received at a manufacturer/repair facility, accepting a case for inspection, marking a case as having a repair report ready, and updating a case to ship out a repaired product.

In a preferred embodiment, manufacturer portal 3212 submits requests corresponding to the operational actions of FIG. 46 to repair system 3214 as workflow transition requests. Repair system 3214 enforces a server-side state transition table and, when a requested transition is permitted, updates a repair order record, increments a state version value, and emits a state-transition event including an event nonce for consumption by mobile application 3204.

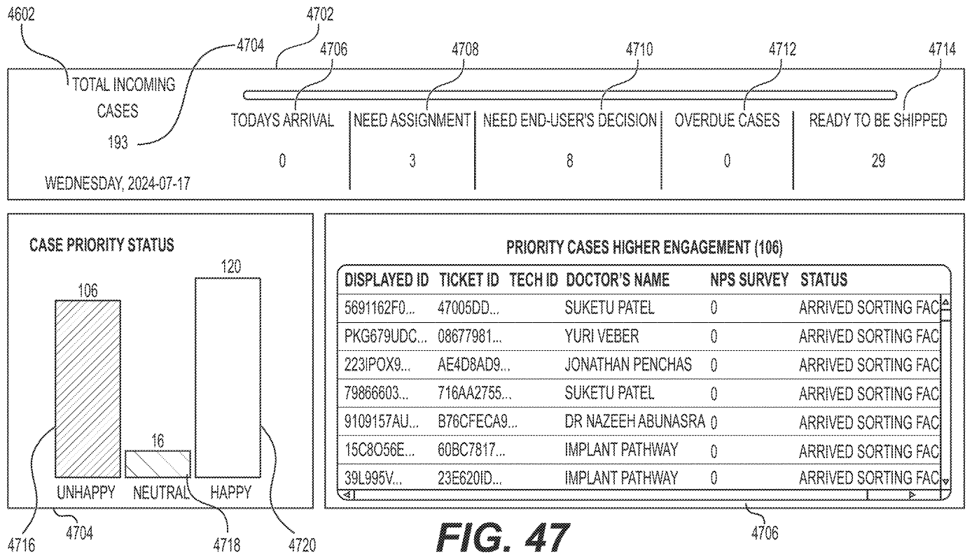

FIG. 47 depicts monitor board 4602 including case number index 4702, case priority status visualization 4704, and priority case listing 4706. Case number index 4702 displays a plurality of operational categories including total incoming cases 4708, today's arrival 4710, need assignments 4712, need end-user's decision 4714, overdue cases 4716, and ready to be shipped 4718, each category presenting a corresponding count. Case priority status visualization 4704 may also present one or more displayed priority-status counts, including displayed count 4720, for urgency classifications associated with the cases.

In a preferred embodiment, case priority status visualization 4704 presents aggregated case counts by urgency classification, including at least unhappy, neutral, and happy categories, and priority cases listing 4706 presents case rows that include at least a displayed identifier, a ticket identifier, a technician identifier or name, an end-user/doctor identifier or name, and an associated status field.

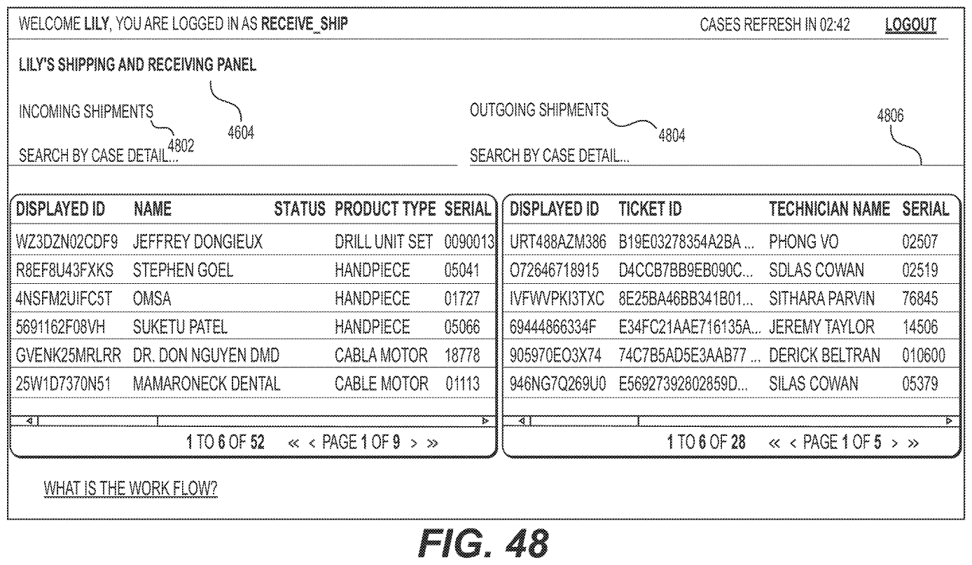

FIG. 48 depicts receive shipment panel 4604 including incoming shipments section 4802, outgoing shipments section 4804, and search field 4806 configured to locate cases by one or more identifiers. The panel displays a table including columns for at least displayed identifier, end-user or customer name, status, product type, and serial information, and includes a selectable control enabling navigation to additional pages of case entries.

In a preferred embodiment, selecting a displayed case entry in FIG. 48 causes manufacturer portal 3212 to present a case-detail interface and to submit a workflow transition request to repair system 3214 when an authorized user requests a status modification.

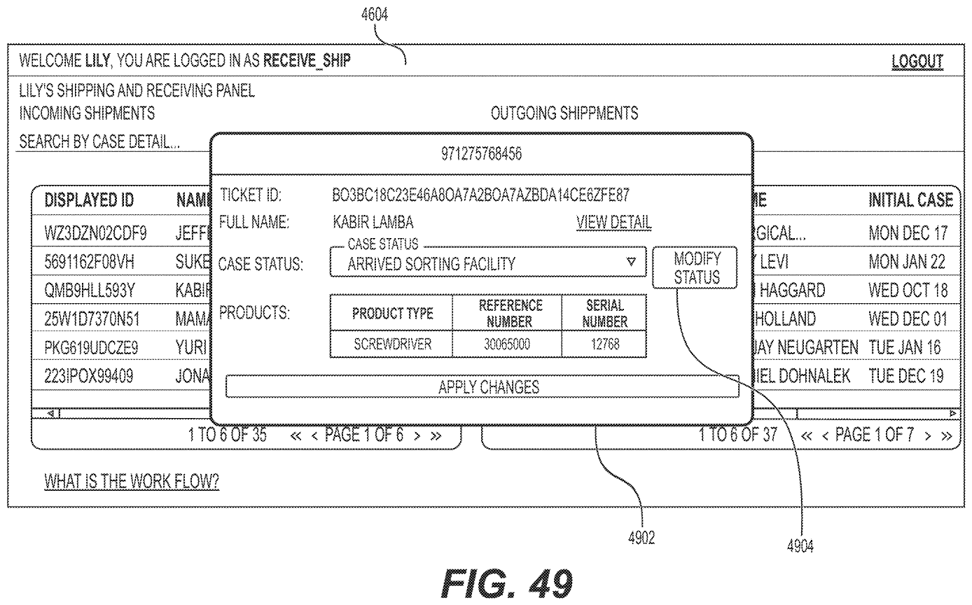

FIG. 49 depicts a status screen 4902 for a selected repair order, including case detail fields and modify status button 4904. The interface includes a selectable case-status control (e.g., a dropdown) and displays product-related fields including at least a product type and a serial or reference field, and further includes an apply-changes control that, when selected, initiates submission of a corresponding transition request.

In a preferred embodiment, upon selection of the apply-changes control of FIG. 49, manufacturer portal 3212 transmits a requested transition to repair system 3214. Repair system 3214 verifies that the transition is permitted by the server-side state transition table and, when permitted, updates the repair order record, increments the state version value, and emits a state-transition event including an event nonce to mobile application 3204.

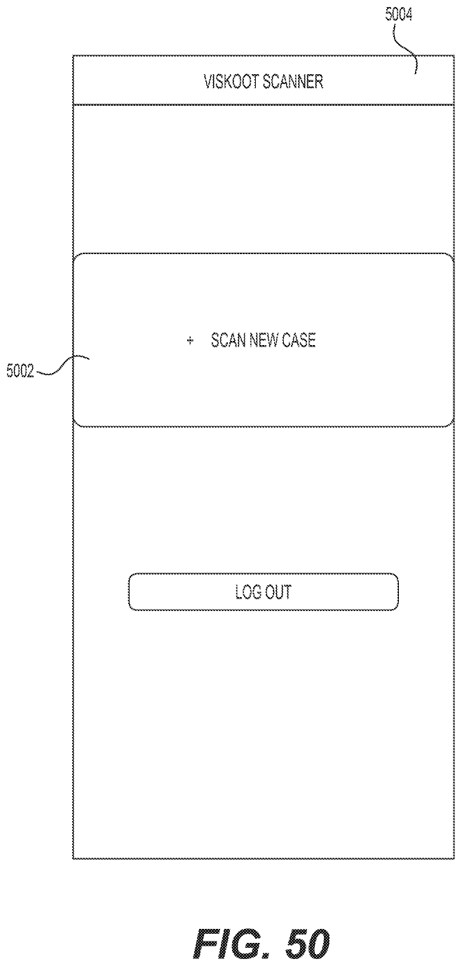

FIG. 50 depicts a scanner interface 5004 including a scan new case control 5002. Selection of scan new case control 5002 initiates a scanning operation to capture a machine-readable code associated with a repair order.

In a preferred embodiment, the scanning operation performed via scanner interface 5004 decodes one or more fields from the machine-readable code, including at least a repair order identifier (e.g., confirmation/ticket identifier) and an integrity value, and prepares the decoded fields for submission to repair system 3214.

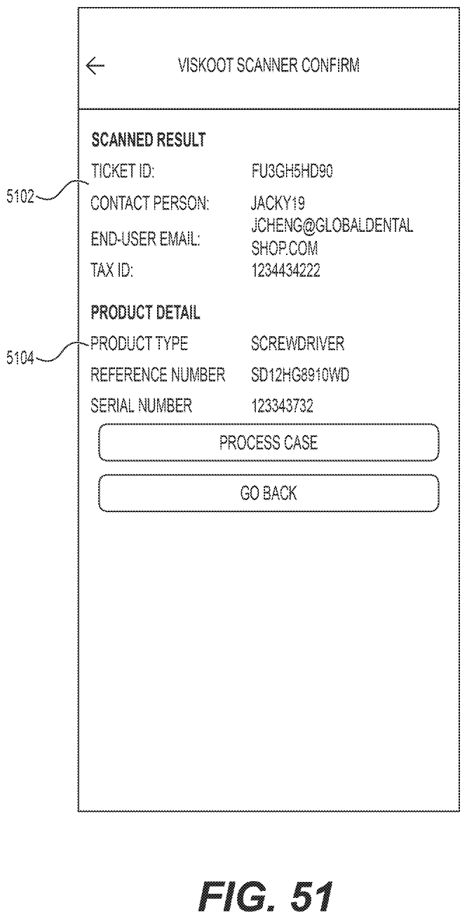

In a preferred embodiment, manufacturer portal 3212 transmits the decoded fields obtained from the scanner interface 5004 to repair system 3214 for intake processing, wherein subsequent receipt verification and any workflow transition to a received state are performed by repair system 3214 as described with respect to FIG. 51.

FIG. 51 depicts an example scanner confirmation screen displayed after scanning machine-readable code 3804. The confirmation screen includes a scanned result region 5102 presenting decoded identifying fields (e.g., ticket identifier and end-user contact information) and a product detail region 5104 presenting product attributes including a product type, a reference number, and a serial number. The screen further includes a selectable process case control configured to initiate intake processing for the decoded repair order, and a go back control configured to return to a prior scanner page.

In a preferred embodiment, selection of the process case control causes manufacturer portal 3212 to transmit a case-intake request to repair system 3214 including at least the decoded repair order identifier and the integrity value. Repair system 3214 validates the integrity value and verifies the repair order identifier against a stored repair order record and, upon successful validation, may advance the repair order record to a received workflow state, increment a state version value, and emit a corresponding state-transition event including an event nonce.

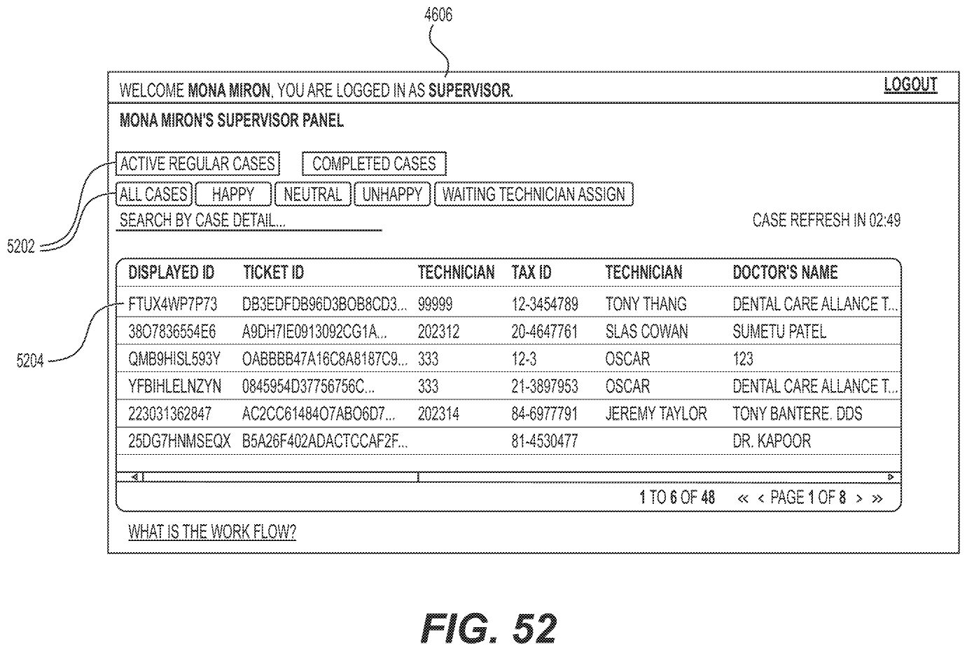

FIG. 52 depicts an example supervisor panel 4606 that enables supervisory review of repair cases and assignment activity. The supervisor panel 4606 includes one or more selectable filters 5202 (e.g., active cases and completed cases) and may further include priority filters corresponding to urgency categories (e.g., unhappy, neutral, happy). The supervisor panel 4606 also includes a search control enabling lookup of cases by identifying information, and a tabular case listing 5204 in which each row corresponds to a case and includes fields such as a displayed ticket ID, technician identifier, tax ID, and a doctor or account name.

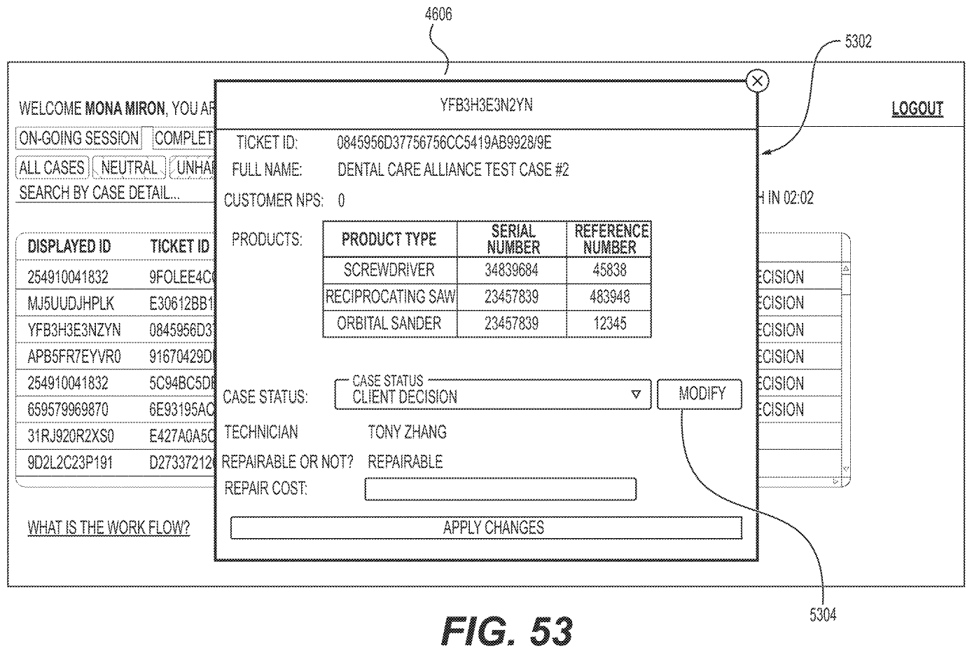

FIG. 53 depicts a case detail and modification interface presented in response to selection of a case row from the supervisor panel 4606. The interface includes a case detail region 5302 presenting case identifiers and product attributes, and a modification control 5304 that enables a supervisor to modify at least a case status value and a technician assignment. In a preferred embodiment, when a supervisor applies changes, manufacturer portal 3212 transmits a corresponding workflow transition request to repair system 3214, and repair system 3214 permits the transition only when a corresponding transition rule in a server-side state transition table is satisfied.

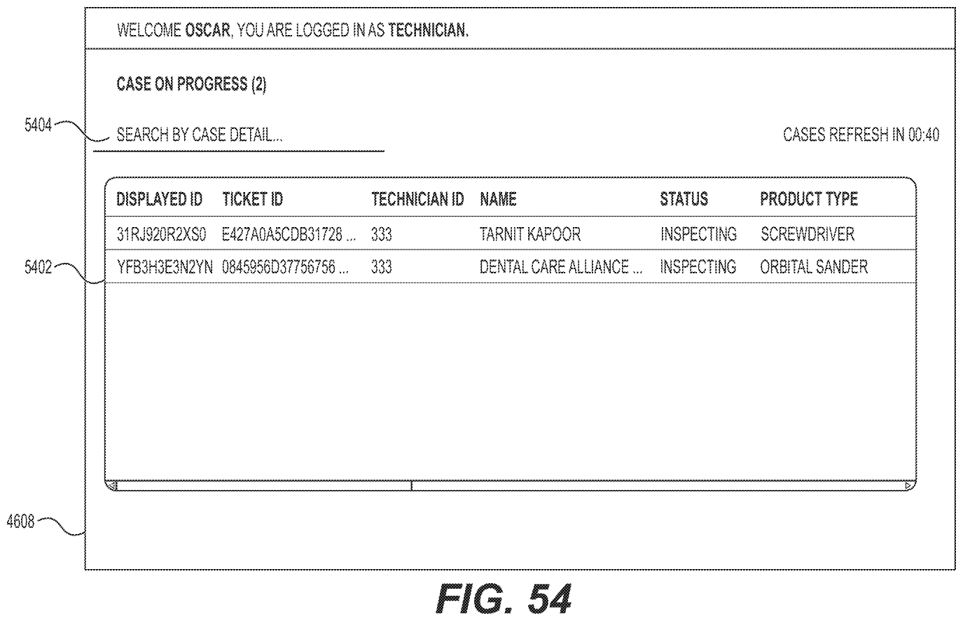

FIG. 54 depicts an example technician panel 4608 that lists cases currently assigned to a technician. The technician panel 4608 presents a listing 5402 that includes fields such as a displayed ticket ID, a case or customer name, a case status (e.g., inspecting), and a product type. The technician panel 4608 may further include a search by case detail control 5404 and a refresh control to update the displayed list. In a preferred embodiment, the case status displayed on technician panel 4608 is updated solely in response to validated state-transition events received from repair system 3214.

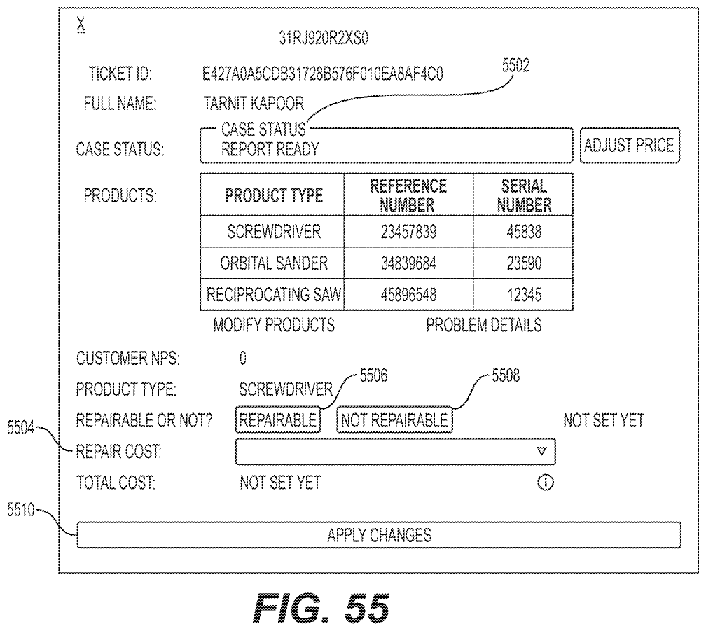

FIG. 55 depicts a repair update interface including case status field 5502 that enables a technician to set a repair outcome and advance a case to a report-ready workflow state. The interface includes product fields (e.g., product type, reference number, serial number) and selection controls enabling the technician to classify the case as repairable or not repairable (e.g., repairable control 5506 and not repairable control 5508). The interface further includes cost entry region 5504 enabling entry of repair cost and/or total cost, and applying changes control 5510 to submit the updated status. In a preferred embodiment, selecting apply changes causes manufacturer portal 3212 to transmit a workflow transition request to repair system 3214, and, when permitted, repair system 3214 increments the state version value and emits a state-transition event including an event nonce that triggers milestone updates in mobile application 3204.

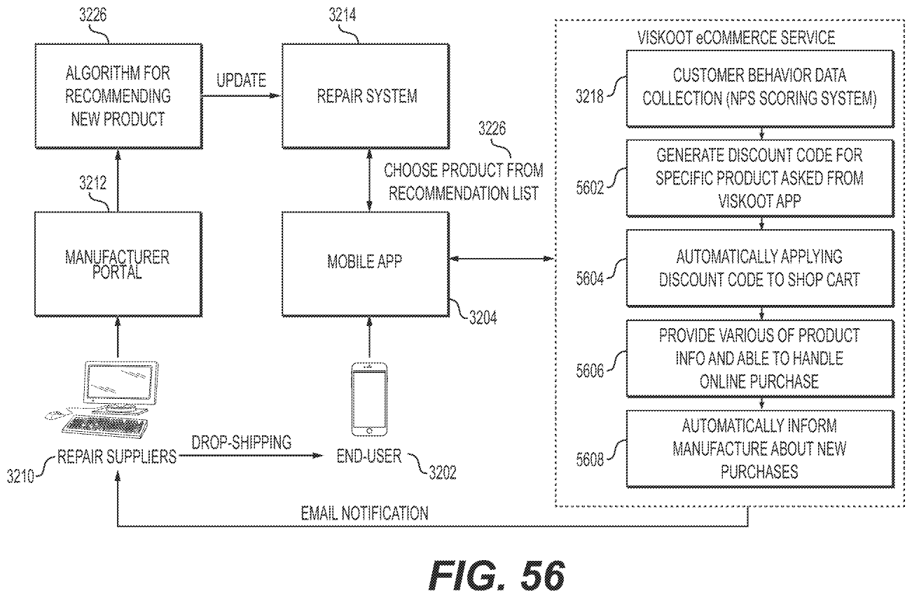

FIG. 56 depicts an example replacement and product recommendation workflow in which repair system 3214 coordinates product recommendation and discount issuance. In a preferred embodiment, repair system 3214 selects a replacement product for display to the end-user 3202 and may utilize customer behavior data collection 3218 in connection with the recommendation process. When the end-user 3202 selects a product recommendation, repair system 3214 generates a discount identifier in step 5602 based on eligibility criteria including one or more of end-user status, warranty entitlement, repair status, purchase price, association, or other exchange-program criteria. In a preferred embodiment, repair system 3214 verifies an entitlement credential before issuing the discount identifier. The discount identifier may comprise a machine-readable token bound to at least a repair order identifier and an expiration time, and the token may be cryptographically signed. The discount identifier is automatically applied to the purchase price during checkout in step 5604. In step 5606, product information and other information used to handle the online purchase are provided to the end-user 3202. After payment, and in step 5608, repair system 3214 automatically informs manufacturer portal 3212 and/or repair suppliers 3210 of the new purchase and transmits replacement order details for fulfillment. The token may be rejected when the repair status does not match a replacement workflow state, when the token is expired, or when signature validation fails.

Unless expressly stated otherwise, the technical modules described with respect to FIGS. 57-67 may be implemented in connection with the medical-device embodiment, the power-tool embodiment, or other serviceable consumer-product embodiments described herein.

### Core Technical Modules

### Image-Based Fault Identification and Closed-Loop Capture Control

FIG. 57 depicts an image-capture and descriptor-generation workflow executed by mobile application 104 during a fault identification process. The workflow begins with capture of an image of a consumer product 5702. The captured image is evaluated by a quality evaluation module 5704 that computes at least a focus score and an illumination score 5706.

The quality evaluation module compares the computed focus score and illumination score to an objective image-quality threshold. If the captured image fails the objective image-quality threshold, mobile application 104 presents a recapture prompt 5708 and rejects the image prior to feature extraction.

When the captured image satisfies the objective image-quality threshold, mobile application 104 performs a region-of-interest (ROI) template check and an angle check 5712 to determine whether the captured image satisfies predefined capture guidance associated with a product type.

If the ROI template check or angle check fails, mobile application 104 displays ROI guidance overlays and requests recapture. If the ROI template check passes, the captured image is preprocessed 5714, including one or more of denoising, illumination normalization, and grayscale conversion.

After preprocessing, mobile application 104 extracts feature descriptors from the captured image 5716 and transmits the extracted feature descriptors to repair system 114 without transmitting the captured image 5718.

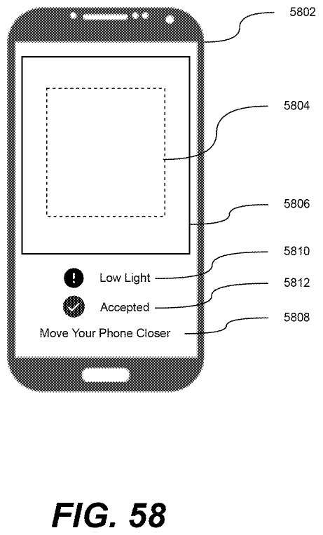

FIG. 58 depicts an example capture-guidance interface displayed by mobile application 104 during image acquisition. The interface of the mobile device 5802 includes a display region 5804 and a region-of-interest overlay 5806 defining an acceptable capture area for the product.

The interface further presents visual feedback indicators including a rejection message indicator 5810 (e.g., low light indicator), an acceptance indicator 5812, and a capture guidance message 5808 instructing the end user to adjust device position or distance. The indicators update dynamically in response to computed image-quality metrics.

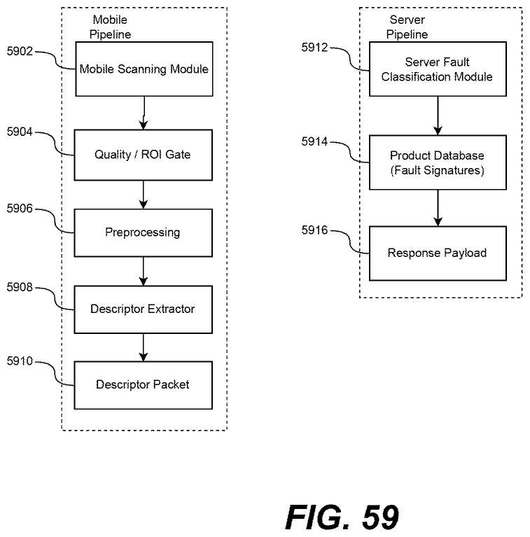

FIG. 59 depicts a distributed fault-identification pipeline comprising a mobile pipeline and a server pipeline. In the mobile pipeline, mobile scanning module 5902 acquires a fault-indication image and applies quality and ROI gate 5904 using the objective image-quality threshold and ROI/angle checks described above with respect to FIGS. 57-58. When the gates pass, preprocessing module 5906 performs the preprocessing operations described above, descriptor extractor 5908 extracts feature descriptors, and descriptor packet generator 5910 packages the extracted descriptors and associated capture metadata for transmission to repair system 114 without transmitting the captured image.

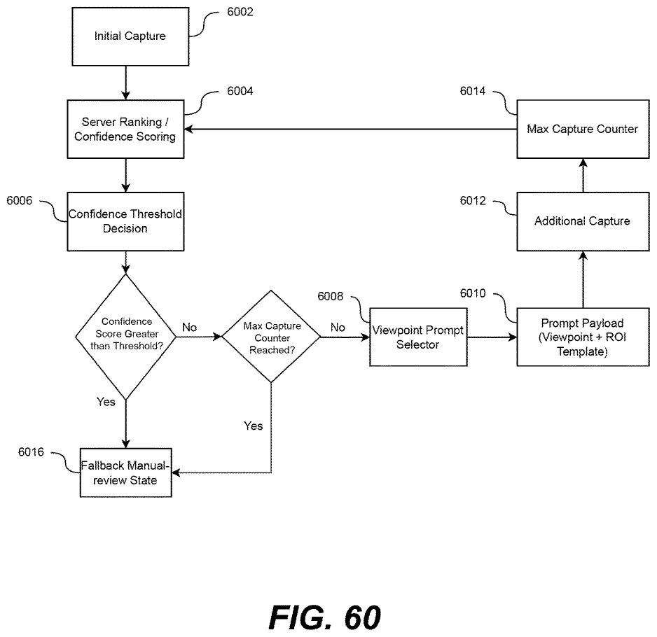

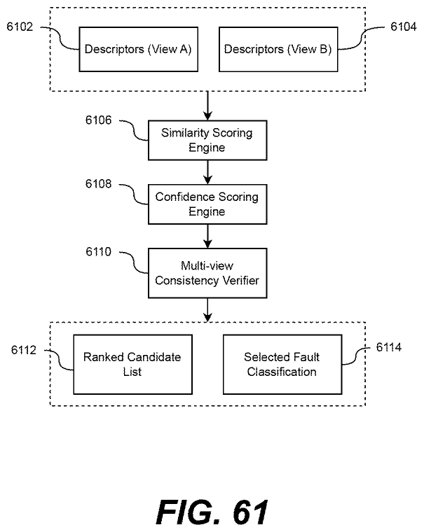

In the server pipeline, fault classification module 5912 receives the descriptor packet generated by the mobile pipeline and compares the received feature descriptors to fault signatures 5914 stored in the product database to generate similarity scores and confidence scores. The resulting scores are used to rank candidate fault classifications and to drive the confidence-controlled processes described with respect to FIGS. 60-61, including additional-viewpoint capture requests when confidence is below a threshold and multi-view consistency verification when multiple viewpoints are available. Response payload generator 5916 outputs a response identifying at least a selected fault classification and related confidence information for use by mobile application 104.

FIG. 60 depicts a closed-loop capture-control process executed by repair system 114. After an initial capture 6002, repair system 114 computes ranking and confidence scores for candidate fault classifications 6004 and evaluates whether a confidence threshold is satisfied 6006.

When the confidence threshold is not satisfied, repair system 114 determines whether a maximum capture counter has been reached. If the maximum capture counter has not been reached, repair system 114 selects an additional viewpoint prompt 6008 and transmits a prompt payload including a viewpoint and ROI template to mobile application 104 6010 to request an additional capture 6012. The repair system 114 then increments maximum capture counter 6014 by one.

If the confidence threshold is satisfied, repair system 114 proceeds with fault classification. If the maximum capture counter is reached without satisfying the confidence threshold, repair system 114 transitions the repair case to a fallback manual review state 6016.

FIG. 61 depicts a multi-view fault classification process. Feature descriptors extracted from a plurality of viewpoints (6102, 6104) are processed by a similarity scoring engine 6106 to generate similarity scores for candidate fault classifications.

The similarity scores are evaluated by a confidence scoring engine 6108, and a multi-view consistency verifier 6110 enforces cross-view consistency constraints. Candidate fault classifications that fail the multi-view consistency verification are rejected.

The output of the multi-view classification process includes a ranked candidate list 6112 and a selected fault classification 6114 having a confidence score satisfying the confidence threshold.

### Machine-Gated Corrective Procedure Execution

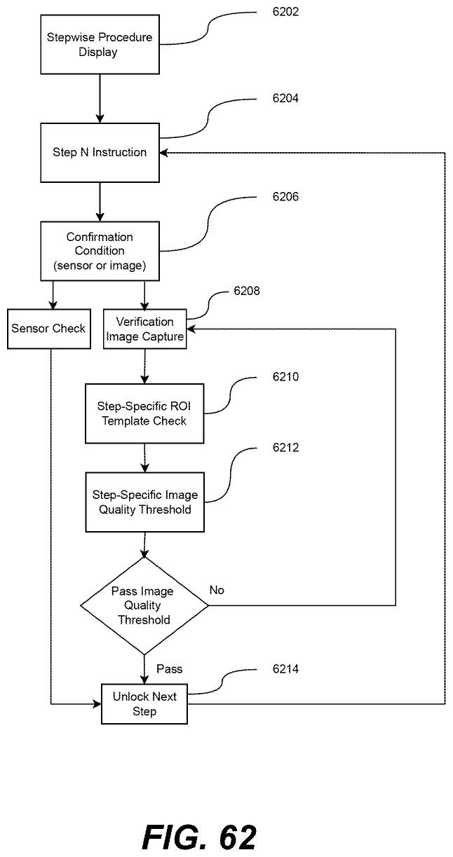

FIG. 62 depicts a stepwise corrective-action procedure displayed by mobile application 104 in response to a selected fault classification. The procedure includes a stepwise procedure display 6202 and a step instruction 6204 corresponding to a corrective action.

For each step, mobile application 104 evaluates a confirmation condition 6206 that may include a sensor check or analysis of a verification image captured by the scanning module 6208. Verification images are evaluated against step-specific ROI templates 6210 and step-specific image-quality thresholds 6212.

When the confirmation condition is satisfied, mobile application 104 unlocks a subsequent step 6214. When the confirmation condition is not satisfied, mobile application 104 prevents progression and requests corrective recapture or adjustment.

### Server-Enforced Workflow State Management and Event Validation

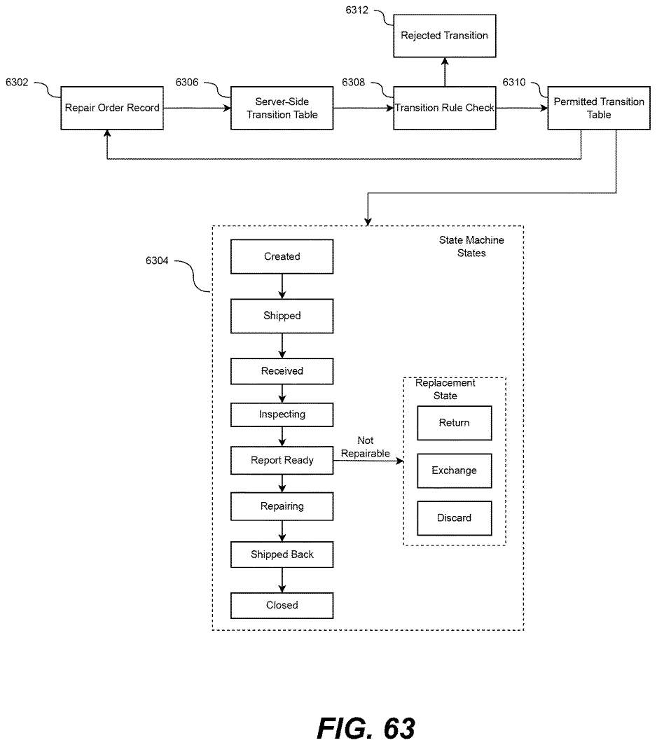

FIG. 63 depicts an example server-side workflow enforcement architecture for a repair order. A repair order record 6302 is associated with a machine-defined state machine 6304 comprising a plurality of discrete workflow states including created, shipped, received, inspecting, report ready, repairing, shipped back, and closed, as well as one or more replacement-related states.

In a preferred embodiment, repair system 3214 maintains a server-side transition table 6306 defining permitted transitions between workflow states. A transition rule check module 6308 evaluates a requested state transition against the server-side transition table 6306.

When a requested transition does not satisfy a corresponding transition rule, the transition is rejected 6312 and the repair order record 6302 remains unchanged. When the requested transition is permitted, the transition is applied via a permitted transition table 6310 and the repair order record 6302 is updated to a new workflow state.

In a preferred embodiment, replacement-related states, including return, exchange, and discard, are reachable only from defined workflow states (e.g., report ready) and only when repairability criteria or cost thresholds are satisfied, thereby preventing unauthorized or out-of-order replacement actions.

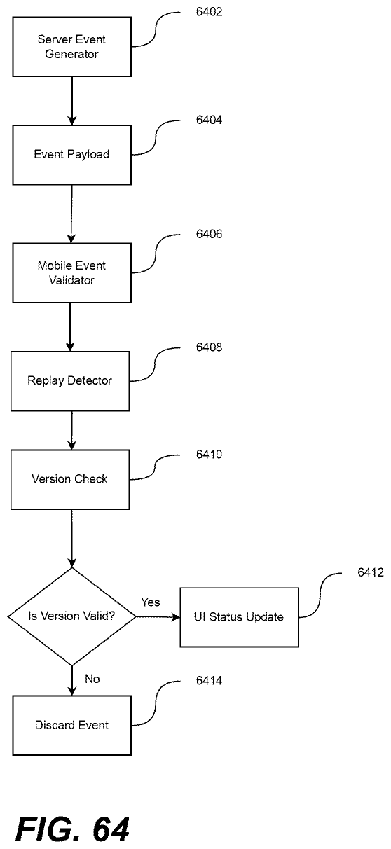

FIG. 64 depicts an example of state-transition event delivery and validation flow. A server event generator 6402 produces a state-transition event payload 6404 in response to a permitted workflow transition.

The event payload 6404 is transmitted to a mobile application and processed by a mobile event validator 6406. In a preferred embodiment, the mobile event validator 6406 includes a replay detector 6408 and a version check module 6410.

The replay detector 6408 rejects events that reuse a previously processed nonce, and the version check module 6410 verifies that a state version value associated with the event matches an expected version progression.

When the event passes validation, a user interface status update 6412 is performed. When validation fails, the event is discarded 6414 without updating any displayed status, thereby preventing stale, duplicated, or malicious state updates from being rendered.

### Integrity-Protected Intake and Receipt Verification

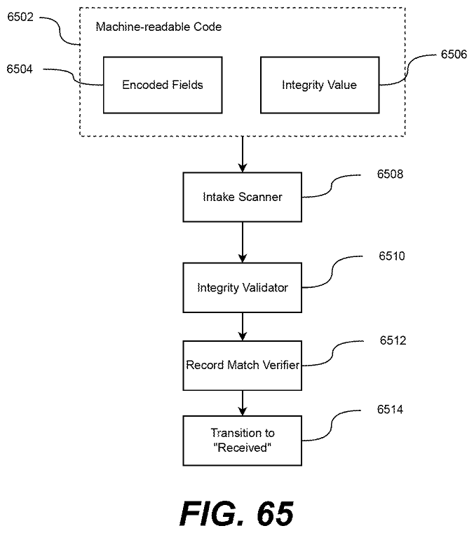

FIG. 65 depicts an example intake workflow using a machine-readable code 6502 associated with a repair order. The machine-readable code 6502 encodes one or more fields 6504 and an integrity value 6506.

An intake scanner 6508 decodes the machine-readable code 6502 and transmits decoded fields to an integrity validator 6510. The integrity validator 6510 verifies that the integrity value 6506 corresponds to the encoded fields.

A record match verifier 6512 confirms that the decoded repair order identifier corresponds to a stored repair order record. Upon successful integrity and record verification, repair system 3214 transitions the repair order to a received state 6514.

In a preferred embodiment, integrity or record verification failure causes the intake process to halt and prevents the repair order from advancing to the received workflow state.

### Replacement Workflow, Entitlement Verification, and Discount Token Issuance

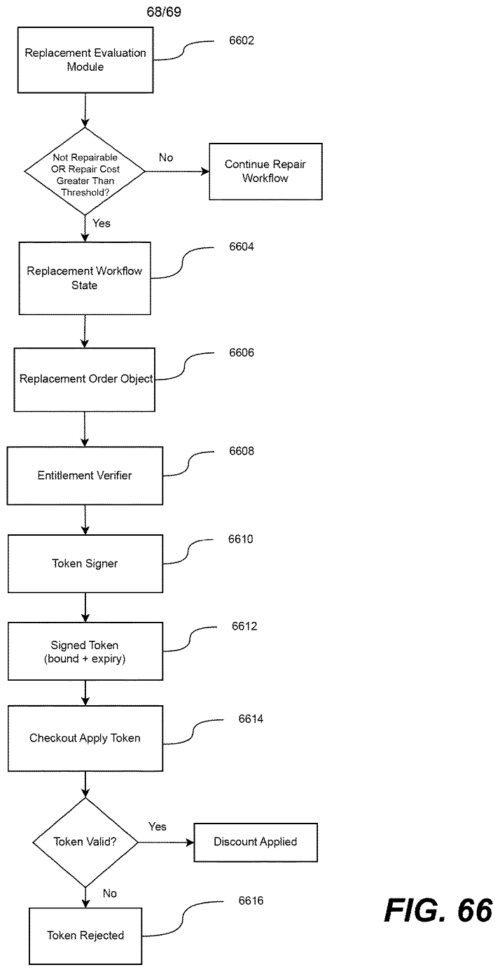

FIG. 66 depicts an example replacement evaluation and discount issuance workflow. Replacement evaluation module 6602 determines whether a repair case satisfies replacement criteria, including whether the product is not repairable or whether a computed repair cost exceeds a replacement threshold. When the replacement criteria are not satisfied, repair system 3214 continues the ordinary repair workflow and does not transition the repair order into the replacement workflow shown in FIG. 66. When the replacement criteria are satisfied, repair system 3214 transitions the repair order to replacement workflow state 6604 and creates replacement order object 6606. Entitlement verifier 6608 then evaluates whether a discount-associated entitlement condition is satisfied, including at least one of warranty status, end-user status, or repair state. Upon successful verification, token signer 6610 generates cryptographically signed token 6612 bound to at least a repair order identifier and an expiration time. During checkout, the signed token is applied 6614. If token validation succeeds, a discount is applied. If token validation fails, the token is rejected 6616 and no discount is granted.

### Compatibility Signature and Replacement Product Filtering

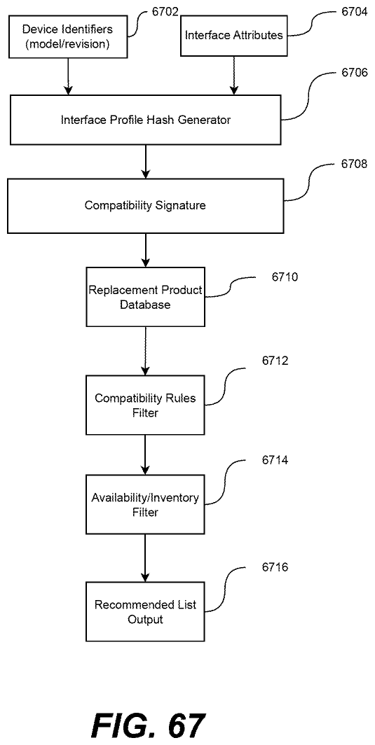

FIG. 67 depicts an example compatibility-based replacement product selection workflow. Device identifiers 6702 and interface attributes 6704 are provided to an interface profile hash generator 6706.

The interface profile hash generator 6706 produces a compatibility signature 6708 that characterizes interface and compatibility attributes of an original product.

The compatibility signature 6708 is used to query a replacement product database 6710. One or more compatibility rules 6712 and availability or inventory filters 6714 are applied to identify suitable replacement products.

The resulting recommended list output 6716 is provided for presentation to an end-user via a product recommendation interface.

In a preferred embodiment, repair system 3214 enforces inventory and availability filtering when selecting replacement products, wherein availability includes at least current stock levels, inventory status, and shipment constraints associated with candidate replacement products. Replacement products that do not satisfy the availability or shipment constraints are excluded from the recommended list prior to presentation to the end user.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A system for managing and diagnosing repairs of a consumer product, comprising:
(a) a mobile application executed on a mobile device having a processor, the mobile application comprising: (i) a scanning module configured to capture one or more images of the consumer product; (ii) a quality evaluation module configured to compute at least a focus score and an illumination score for each captured image, and to determine whether the captured image satisfies an objective image-quality threshold, wherein the mobile application is configured to reject images that fail the objective image-quality threshold and to request recapture before performing feature extraction; (iii) an image analysis module configured, for each captured image that satisfies the objective image-quality threshold, to preprocess the captured image and extract feature descriptors from the captured image; and (iv) a transmission module configured to transmit the feature descriptors without transmitting the captured image to a server; and (b) a repair application executed on the server, the repair application comprising: (i) a fault classification module configured to compare the feature descriptors to fault signatures stored in a product database, compute a similarity score and a confidence score for each candidate fault classification, and rank the candidate fault classifications based at least in part on the confidence scores; (ii) a closed-loop capture control module configured, when a highest-ranked candidate fault classification has a confidence score below a confidence threshold, to cause the mobile application to request capture of an additional image from an additional viewpoint selected from a predetermined set of viewpoint prompts associated with a product type and a region-of-interest template, and to receive additional feature descriptors extracted from the additional image and repeat the comparison and ranking using the additional feature descriptors until (A) the confidence score satisfies the confidence threshold or (B) a maximum number of image captures is reached; and (iii) a response module configured to transmit to the mobile application a selected fault classification and a corresponding corrective action instruction associated with the selected fault classification in the product database, wherein the mobile application is configured to display the corrective action instruction and to enable initiation of a repair case based on the selected fault classification.

2. The system of claim 1, wherein the consumer product comprises a power tool or a medical device, wherein the product database stores fault signatures specific to a product type of the consumer product, and wherein the mobile application further provides product-type-specific capture guidance that defines at least one of a region-of-interest template or an image-capture angle range for the product type, and machine-enforces the capture guidance by rejecting images that do not satisfy the region-of-interest template or the image-capture angle range.

3. The system of claim 1, wherein preprocessing each captured image comprises one or more of:
(a) denoising the captured image;
(b) performing illumination normalization; and
(c) converting the captured image to a grayscale representation, prior to extracting the feature descriptors.

4. The system of claim 1, wherein computing the confidence score for each candidate fault classification comprises computing a weighted match score based on (i) a number of descriptor matches exceeding a similarity threshold, (ii) match quality, and (iii) consistency of matches across a plurality of viewpoints, and wherein ranking the candidate fault classifications is based at least in part on the weighted match scores,
wherein the consistency across the plurality of viewpoints includes a cross-view constraint that rejects a candidate fault classification when purported matching descriptors fail a multi-view consistency test.

5. The system of claim 1, wherein the corrective action instruction comprises at least one of a video or a plurality of images arranged as a stepwise visual procedure, and wherein the mobile application is configured to machine-enforce a step sequence by gating display of a subsequent step until a confirmation condition is satisfied, the confirmation condition comprising at least one of:
(a) receipt of a user confirmation; (b) detection of a sensor condition; or (c) analysis of a verification image captured by the scanning module, wherein, when the confirmation condition comprises analysis of the verification image, the verification image is evaluated against a step-specific region-of-interest template and is rejected unless the verification image satisfies a step-specific image-quality threshold.

6. The system of claim 1, wherein the repair application further comprises a product recommendation module configured to, when the selected fault classification indicates that the consumer product is not repairable and when the selected fault classification is selected with a confidence score satisfying the confidence threshold, initiate a replacement workflow by generating a replacement order object associated with a repair case and transitioning the repair case to a replacement state.

7. The system of claim 6, wherein the product recommendation module selects a replacement product from a plurality of replacement products based on a computed compatibility signature for the consumer product, the compatibility signature including one or more technical attributes comprising at least one of a model identifier, a revision identifier, or an interface profile hash, wherein the interface profile hash is computed from one or more device interface attributes captured by the mobile application or stored by the server, and wherein the computed compatibility signature is stored in association with the repair case.

8. The system of claim 7, wherein the plurality of replacement products is stored in a product recommendation database associating consumer product identifiers with compatible replacement products, and wherein selecting the replacement product further comprises applying at least one filter comprising availability, inventory status, or revision compatibility, wherein revision compatibility is determined by comparing the revision identifier or the interface profile hash to a stored compatibility rule for the replacement product.

9. A system for managing repairs of a consumer product, comprising:
(a) a server comprising a repair system configured to:
(i) create and store a repair order record including a repair order identifier and a product identifier;
(ii) generate a machine-readable code encoding at least the repair order identifier, the product identifier, a shipment tracking identifier, and an integrity value comprising at least one of a checksum or a cryptographic signature;
(iii) upon receipt of a package associated with the consumer product, scan the machine-readable code, validate the integrity value, and verify the repair order identifier against the stored repair order record;
(iv) maintain a machine-defined state workflow for the repair order record comprising a plurality of states and a server-side state transition table, wherein advancement from a current state to a subsequent state is permitted only when a corresponding transition rule in the state transition table is satisfied; and
(v) generate, upon each permitted state advancement, a state-transition event that includes the repair order identifier, a state version value, and an event nonce, and transmit the state-transition event to a mobile application; and
(b) the mobile application executed on a mobile device, the mobile application configured to:
(i) receive the state-transition event;
(ii) validate the state version value and the event nonce; and
(iii) update a displayed repair status solely based on validated state-transition events received from the server.

10. The system of claim 9, wherein the mobile application further comprises an information update module configured to receive a plurality of repair milestones derived from the machine-defined state workflow and to display corresponding milestone indicators on the mobile device, wherein a milestone indicator is rendered or updated only upon receiving a validated state-transition event.

11. The system of claim 10, wherein selection of a milestone indicator by an end user causes the mobile application to transmit a milestone detail request that includes the repair order identifier and a current state version value, and wherein the repair system transmits milestone details only when the current state version value matches the repair order record.

12. The system of claim 11, wherein each milestone transmitted to the mobile application includes the repair order identifier, the state version value, and the event nonce, and wherein the mobile application discards a milestone payload when at least one of (i) the repair order identifier does not match a locally stored repair order identifier, (ii) the state version value is stale, or (iii) the event nonce indicates a replayed event.

13. The system of claim 9, wherein the repair system further comprises a replacement evaluation module configured to compute a repair cost based on measured repair resources comprising at least one of diagnostic time, scanned part identifiers, or logged technician task code identifiers, wherein the measured repair resources are captured as machine-recorded events in the repair order record including at least timestamps and at least one of the scanned part identifiers or the logged technician task code identifiers, compare the computed repair cost to a replacement cost threshold, and automatically transition the repair order record to a replacement workflow state when the computed repair cost meets or exceeds the replacement cost threshold.

14. The system of claim 13, wherein a replacement product is selected from a consumer product database that associates consumer product identifiers with compatible replacement products based on a compatibility signature including one or more technical attributes comprising at least one of a model identifier, a revision identifier, or an interface profile hash, wherein the compatibility signature is computed and stored in association with the repair order record.

15. The system of claim 14, wherein the repair system is further configured to generate a discount identifier for the replacement product only after verifying a machine-verifiable user entitlement credential, and wherein the discount identifier comprises a machine-readable token configured to be applied automatically during replacement purchase checkout based on at least one of a repair status or the user entitlement credential, wherein the machine-readable token comprises a cryptographically signed token bound to at least the repair order identifier and a token expiration time, and wherein the token is rejected when the repair status does not match the replacement workflow state, when the token is expired, or when signature validation fails.
